(19) United States
(12) Patent Application Publication
(10) Pub. No.: US 2026/0202566 A1
(43) Pub. Date: Jul. 16, 2026

(54) SEISMIC IMAGING FRAMEWORK

(71) Applicant: Schlumberger Technology Corporation, Sugar Land, TX (US)

(72) Inventors: Son Dang Thai Phan, Houston, TX (US); Wenyi Hu, Fulshear, TX (US); William Sanger, Houston, TX (US); Zhimei Yan, Houston, TX (US); Daniele Boiero, Houston, TX (US)

(21) Appl. No.: 19/447,080

(22) Filed: Jan. 13, 2026

Related U.S. Application Data
(60) Provisional application No. 63/745,097, filed on Jan. 14, 2025.

(51) Int. Cl. G01V 1/30; G01V 1/28; G01V 1/32

(52) U.S. Cl. CPC G01V 1/301; G01V 1/282; G01V 1/32

(57) ABSTRACT

A method can include receiving seismic data from a seismic survey of a subsurface environment, where the seismic data include indicia of primary reflections and multiple reflections; receiving a multiple model indicative of multiple reflections in the subsurface environment; generating difference values using an unsupervised machine learning model, where the difference values represent differences between the multiple reflections of the seismic data and the multiple reflections of the multiple model; and generating a refined multiple model using the difference values, where the refined multiple model provides for more accurate characterization of locations of structural features in the subsurface environment.

### RELATED APPLICATIONS

This application claims priority to and the benefit of a U.S. Provisional Application having Ser. No. 63/745,097, filed 14 Jan. 2025, which is incorporated by reference herein in its entirety.

### BACKGROUND

Reflection seismology finds use in geophysics to estimate properties of subsurface formations along with identifying positions of such formations in space, which may be utilized to form a map or a model of a subsurface region. Reflection seismology may provide seismic data representing waves of elastic energy as transmitted by P-waves and S-waves, in a frequency range of approximately 1 Hz to approximately 100 Hz. In various instances, seismic data can also represent refractions and/or diving waves. Seismic data may be processed and interpreted to understand better composition, fluid content, extent and geometry of subsurface rocks. For example, an inversion may be implemented as part of a seismic data workflow for building a model of a subsurface environment where information from reflections, refractions and/or diving waves may be considered.

In various instances, seismic data may be subjected to multiples attenuation that attenuates multiple reflections (e.g., multiples), for example, to reduce noise with respect to primary reflections (e.g., primaries), which may be considered signal. Multiples attenuation may be computationally expensive due to a demand to iteratively generate a multiple model where such a model may impose risks of removing desirable signal (e.g., indicia of primaries). Various examples of seismic imaging framework components herein provide an improvement in technology, particularly with respect to multiple model generation, which, in turn, can improve characterization of a subsurface environment through seismic imaging.

### SUMMARY

A method can include receiving seismic data from a seismic survey of a subsurface environment, where the seismic data include indicia of primary reflections and multiple reflections; receiving a multiple model indicative of multiple reflections in the subsurface environment; generating difference values using an unsupervised machine learning model, where the difference values represent differences between the multiple reflections of the seismic data and the multiple reflections of the multiple model; and generating a refined multiple model using the difference values, where the refined multiple model provides for more accurate characterization of locations of structural features in the subsurface environment. A system can include a processor; a memory operatively coupled to the processor; and processor-executable instructions stored in the memory to instruct the system to: receive seismic data from a seismic survey of a subsurface environment, where the seismic data include indicia of primary reflections and multiple reflections; receive a multiple model indicative of multiple reflections in the subsurface environment; generate difference values using an unsupervised machine learning model, where the difference values represent differences between the multiple reflections of the seismic data and the multiple reflections of the multiple model; and generate a refined multiple model using the difference values, where the refined multiple model provides for more accurate characterization of locations of structural features in the subsurface environment. One or more computer-readable storage media can include computer-executable instructions executable to instruct a computing system to: receive seismic data from a seismic survey of a subsurface environment, where the seismic data include indicia of primary reflections and multiple reflections; receive a multiple model indicative of multiple reflections in the subsurface environment; generate difference values using an unsupervised machine learning model, where the difference values represent differences between the multiple reflections of the seismic data and the multiple reflections of the multiple model; and generate a refined multiple model using the difference values, where the refined multiple model provides for more accurate characterization of locations of structural features in the subsurface environment. Various other examples of methods, systems, devices, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a geologic environment;

FIG. 2 illustrates examples of survey techniques;

FIG. 3 illustrates examples of survey techniques;

FIG. 4 illustrates examples of multiple reflections;

FIG. 5 illustrates examples of multiple reflections;

FIG. 6 illustrates example of forward modeling and an example of inversion;

FIG. 7 illustrates an example of an earth model;

FIG. 8 illustrates an example of a workflow;

FIG. 9 illustrates an example of a network architecture;

FIG. 10 illustrates an example of a workflow;

FIG. 11 illustrates an example of a workflow;

FIG. 12 illustrates an example of a table;

FIG. 13 illustrates examples of seismic data and multiple models and multiple attenuated seismic data;

FIG. 14 illustrates examples of seismic data and a multiple model and examples of difference values;

FIG. 15 illustrates an example of a method and an example of a system;

FIG. 16 illustrates an example of a computational framework; and

FIG. 17 illustrates components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

As mentioned, reflection seismology finds use in geophysics to estimate properties of subsurface formations along with identifying positions of such formations in space, which may be utilized to form a map or a model of a subsurface region. In such an example, characteristics of the subsurface region may be previously unknown or, for example, one or more wells may be drilled into the subsurface region where physical matter (e.g., cores) and/or sensor-based data (e.g., imagery, resistivity, NMR, etc.) may be available to assist in correlating seismic imagery to the physical reality (e.g., the structure and makeup of the subsurface region). Reflection seismology can provide seismic data representing waves of elastic energy, as transmitted by P-waves and S-waves, in a frequency range of approximately 1 Hz to approximately 100 Hz or optionally less than 1 Hz and/or optionally more than 100 Hz. Seismic data may be processed and interpreted to understand better composition, fluid content, extent and geometry of subsurface rocks.

As explained, in various instances, seismic data may be subjected to multiples attenuation that attenuates multiple reflections (e.g., multiples), for example, to reduce noise with respect to primary reflections (e.g., primaries), which may be considered signal. Multiples attenuation may be computationally expensive due to a demand to iteratively generate a multiple model where such a model may impose risks of removing desirable signal (e.g., indicia of primaries). Various examples of seismic imaging framework components herein provide an improvement in technology, particularly with respect to multiple model generation, which, in turn, can improve characterization of a subsurface environment through seismic imaging.

In various instances, a generated multiple model may be considered a type of customized, formation-dependent filter that, for example, may be applied to seismic data to generate an improved seismic image of a subsurface region. For example, subsurface structures may be revealed more clearly upon application of a generated multiple model that attenuates multiples (e.g., multiple reflection energy) as positions of such structures may be more accurately identified using primaries (e.g., primary reflection energy) that are not “polluted” with inherently generated multiples by the seismic imaging experiment. In other words, when a seismic source generates seismic energy that travels as seismic waves through a subsurface region, the experimenter has no control over the underlying physics that governs how those seismic waves reflect and how many times they reflect. As explained, an improved multiple model may be generated and applied to address the physics-based shortcomings of a seismic imaging experiment, thereby improving the output thereof. Further, as explained, an improvement in the technology for multiple model generation can make generation more expeditious, and/or allow for generation using fewer resources, which may be fewer resources than for a conventional multiples model (e.g., consider conventional iterative processes that may be resource intensive).

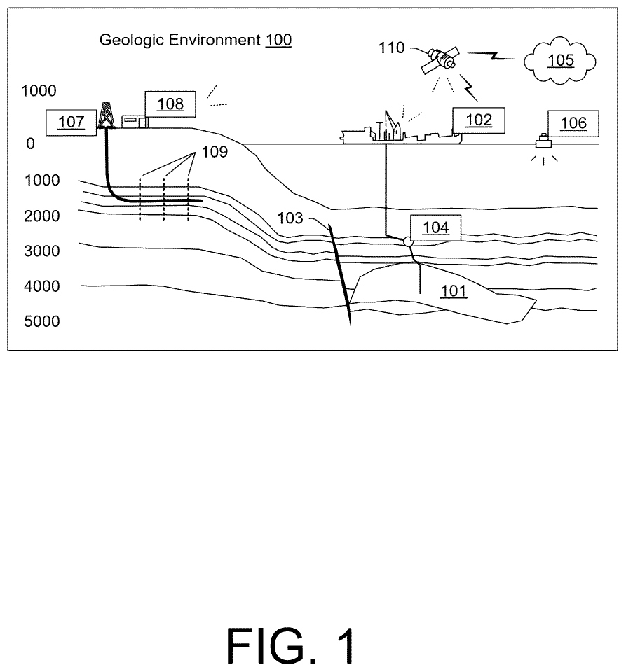

FIG. 1 shows a geologic environment 100 (an environment that includes a sedimentary basin, a reservoir 101, a fault 103, one or more fractures 109, etc.) and an example of an acquisition technique 140 to acquire seismic data (see data 160). A system may process data acquired by the technique 140 to allow for direct or indirect management of sensing, drilling, injecting, extracting, etc., with respect to the geologic environment 100. In turn, further information about the geologic environment 100 may become available as feedback (optionally as input to the system). An operation may pertain to a reservoir that exists in the geologic environment 100 such as the reservoir 101. A technique may provide information (as an output) that specifies one or more location coordinates of a feature in a geologic environment, one or more characteristics of a feature in a geologic environment, etc.

The geologic environment 100 may be referred to as a formation or may be described as including one or more formations. A formation may be a unit of lithostratigraphy such as a body of rock that is sufficiently distinctive and continuous.

A system may be implemented to process seismic data, optionally in combination with other data. Processing of data may include generating one or more seismic attributes, rendering information to a display or displays, etc. A process or workflow may include interpretation, which may be performed by an operator that examines renderings of information (to one or more displays, etc.) and that identifies structure or other features within such renderings. Interpretation may be or include analyses of data with a goal to generate one or more models and/or predictions (about properties and/or structures of a subsurface region).

A system may include features of a framework such as the PETREL seismic to simulation software framework (SLB, Houston, Texas). Such a framework can receive seismic data and other data and allow for interpreting data to determine structures that can be utilized in building a simulation model.

A system may include add-ons or plug-ins that operate according to specifications of a framework environment. As an example, a framework may be implemented within or in a manner operatively coupled to the DELFI cognitive exploration and production (E&P) environment (SLB, Houston, Texas), which is a secure, cognitive, cloud-based collaborative environment that integrates data and workflows with digital technologies, such as artificial intelligence and machine learning. As an example, such an environment can provide for operations that involve one or more frameworks.

As an example, a platform, such as, for example, the LUMI platform (SLB, Houston, Texas) may be utilized. The LUMI platform includes features that provide for artificial intelligence solutions as may be integrated with data management capabilities. The LUMI platform provides for flexible deployment options and an open, secure, and modular architecture, for example, to empower data-driven decision-making. The LUMI platform is operable with the DELFI environment and, hence, one or more of various frameworks. While various platforms, environments, frameworks, libraries, etc., are mentioned, a framework may be operable in an agnostic manner, for example, to be compatible with one or more other platforms, environments, frameworks, libraries, technologies, etc.

Seismic data may be processed using a framework such as the OMEGA framework (SLB, Houston, TX). The OMEGA framework provides features that can be implemented for processing of seismic data through prestack seismic interpretation and seismic inversion.

A framework for processing data may include features for 2D line and 3D seismic surveys. Modules for processing seismic data may include features for prestack seismic interpretation (PSI), optionally pluggable into a framework such as the DELFI framework environment.

In FIG. 1, the geologic environment 100 includes an offshore portion and an on-shore portion. A geologic environment may be or include one or more of an offshore geologic environment, a seabed geologic environment, an ocean bed geologic environment, etc.

The geologic environment 100 may be outfitted with one or more of a variety of sensors, detectors, actuators, etc. Equipment 102 may include communication circuitry that receives and that transmits information with respect to one or more networks 105. Such information may include information associated with downhole equipment 104, which may be equipment to acquire information, to assist with resource recovery, etc. Other equipment 106 may be located remote from a well site and include sensing, detecting, emitting or other circuitry and/or be located on a seabed. Such equipment may include storage and communication circuitry that stores and that communicates data, instructions, etc. One or more satellites may be provided for purposes of communications, data acquisition, etc. FIG. 1 shows a satellite 110 in communication with the network 105 that may be configured for communications, noting that the satellite 110 may additionally or alternatively include circuitry for imagery (spatial, spectral, temporal, radiometric, etc.).

FIG. 1 also shows the geologic environment 100 as optionally including equipment 107 and 108 associated with a well that includes a substantially horizontal portion that may intersect with one or more of the one or more fractures 109; consider a well in a shale formation that may include natural fractures, artificial fractures (hydraulic fractures) or a combination of natural and artificial fractures. The equipment 107 and/or 108 may include components, a system, systems, etc. for fracturing, seismic sensing, analysis of seismic data, assessment of one or more fractures, etc.

A system may be used to perform one or more workflows. A workflow may be a process that includes a number of worksteps. A workstep may operate on data to create new data, to update existing data, etc. A system may operate on one or more inputs and create one or more results based on one or more algorithms. A workflow may be a workflow implementable in the PETREL software that operates on seismic data, seismic attribute(s), etc. A workflow may be a process implementable in the DELFI environment, the LUMI platform, etc. A workflow may include one or more worksteps that access a plug-in (external executable code, etc.). A workflow may include rendering information to a display (a display device). A workflow may include receiving instructions to interact with rendered information to process information and optionally render processed information. A workflow may include transmitting information that may control, adjust, initiate, etc. one or more operations of equipment associated with a geologic environment (in the environment, above the environment, etc.).

As an example, an acquisition technique can be utilized to perform a seismic survey. A seismic survey can acquire various types of information, which can include various types of waves (e.g., P, SV, SH, etc.). A P-wave can be an elastic body wave or sound wave in which particles oscillate in the direction the wave propagates. P-waves incident on an interface (at other than normal incidence, etc.) may produce reflected and transmitted S-waves (e.g., “converted” waves). An S-wave or shear wave may be an elastic body wave in which particles oscillate perpendicular to the direction in which the wave propagates. S-waves may be generated by a seismic energy source (e.g., other than an air gun). S-waves may be converted to P-waves. S-waves tend to travel more slowly than P-waves and do not travel through fluids that do not support shear. Recording of S-waves involves use of one or more receivers operatively coupled to earth (e.g., capable of receiving shear forces with respect to time). Interpretation of S-waves may allow for determination of rock properties such as fracture density and orientation, Poisson's ratio and rock type by crossplotting P-wave and S-wave velocities, and/or by other techniques. Parameters that may characterize anisotropy of media (e.g., seismic anisotropy) include the Thomsen parameters □, □ and □.

Seismic data may be acquired for a region in the form of traces. For example, a technique can utilize a source for emitting energy where portions of such energy (e.g., directly and/or reflected) may be received via one or more sensors (e.g., receivers). Energy received may be discretized by an analog-to-digital converter that operates at a sampling rate. Acquisition equipment may convert energy signals sensed by a sensor to digital samples at a rate of one sample per approximately 4 ms. Given a speed of sound in a medium or media, a sample rate may be converted to an approximate distance. The speed of sound in rock may be of the order of around 5 km per second. Thus, a sample time spacing of approximately 4 ms would correspond to a sample “depth” spacing of about 10 meters (e.g., assuming a path length from source to boundary and boundary to sensor). A trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing scenario is divided by two (e.g., to account for reflection), for a vertically aligned source and sensor, the deepest boundary depth may be estimated to be about 10 km (e.g., assuming a speed of sound of about 5 km per second).

As mentioned, seismic data may be acquired and analyzed to understand better subsurface structure of a geologic environment. Reflection seismology finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz or optionally less than 1 Hz and/or optionally more than 100 Hz). Seismic data may be processed and interpreted, for example, to understand better composition, fluid content, extent and geometry of subsurface rocks.

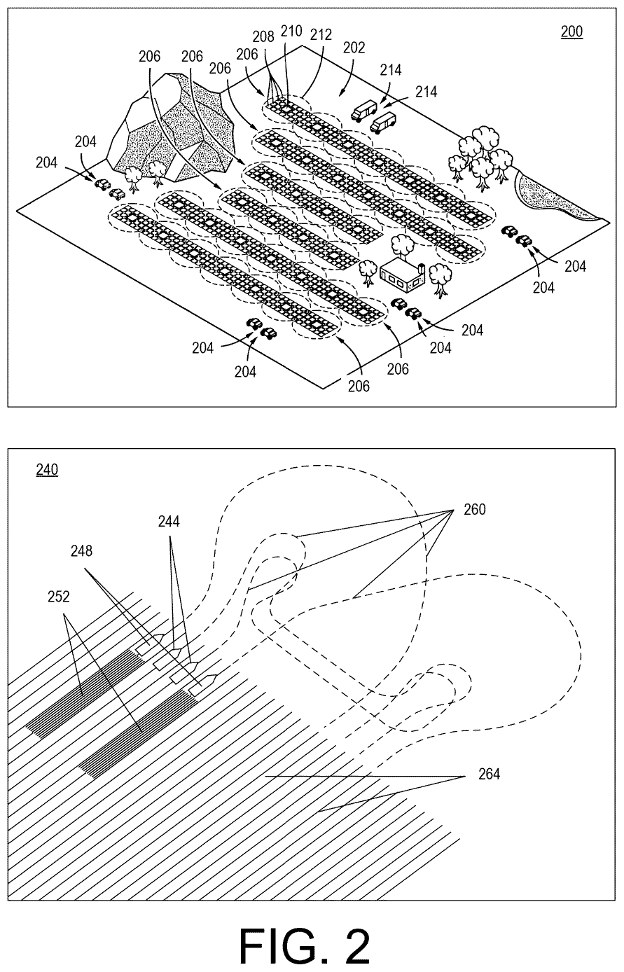

FIG. 2 shows an example of a simplified schematic view of a land seismic data acquisition system 200 and an example of a simplified schematic view of a marine seismic data acquisition system 240.

As shown with respect to the system 200, an area 202 to be surveyed may or may not have physical impediments to direct wireless communication between a recording station 214 (e.g., which may be a recording truck) and a vibrator 204. A plurality of vibrators 204 may be employed, as well as a plurality of sensor unit grids 206, each of which may have a plurality of sensor units 208.

As illustrated in FIG. 2 with respect to the system 200, approximately 24 to about 28 sensor units 208 may be placed in a vicinity (e.g., a region) around a base station 210. The number of sensor units 208 associated with each base station 210 may vary from survey to survey. Circles 212 indicate an approximate range of reception for each base station 210.

In the system 200 of FIG. 2, the plurality of sensor units 208 may be employed in acquiring and/or monitoring land-seismic sensor data for the area 202 and transmitting the data to the one or more base stations 210. Communications between the vibrators 204, the base stations 210, the recording station 214, and the seismic sensors 208 may be wireless (e.g., at least in part via air for a land-based system; or optionally at least in part via water for a sea-based system).

In the system 240 of FIG. 2, one or more source vessels 240 may be utilized with one or more streamer vessels 248 or a vessel or vessels may tow both a source or sources and a streamer or streamers 252. In the example of FIG. 2, the vessels 244 and 248 (e.g., or just the vessels 248 if they include sources) may follow predefined routes (e.g., paths) for an acquisition geometry that includes inline and crossline dimensions. As shown, routes 260 can be for maneuvering the vessels to positions 264 as part of the survey. As an example, a marine seismic survey may call for acquiring seismic data during a turn (e.g., during one or more of the routes 260).

The example systems 200 and 240 of FIG. 2 demonstrate how surveys may be performed according to an acquisition geometry that includes dimensions such as inline and crossline dimensions, which may be defined as x and y dimensions in a plane or surface where another dimension, z, is a depth dimension. As explained, time can be a proxy for depth, depending on various factors, which can include knowing how many reflections may have occurred as a single reflection may mean that depth of a reflector can be approximated using one-half of a two-way traveltime, some indication of the speed of sound in the medium and positions of the receiver and source (e.g., corresponding to the two-way traveltime).

Two-way traveltime (TWT) can be defined as the elapsed time for a seismic wave to travel from its source to a given reflector and return to a receiver (e.g., at a surface, etc.). As an example, a minimum two-way traveltime can be defined to be that of a normal-incidence wave with zero offset.

As an example, a seismic survey can include points referred to as common midpoints (CMPs). In multichannel seismic acquisition, a CMP is a point that is halfway between a source and a receiver that is shared by a plurality of source-receiver pairs. In such a survey, various angles may be utilized that may define offsets (e.g., offsets from a CMP, etc.). In a CMP approach, redundancy among source-receiver pairs can enhance quality of seismic data, for example, via stacking of the seismic data. A CMP can be vertically above a common depth point (CDP), or common reflection point (CRP). As an example, seismic data may be presented as a gather, which can be an image of seismic traces that share an acquisition parameter, such as a common midpoint gather (CMP gather or CMG), which contains traces having a common midpoint (CMP). In such an example, a CMG may be presented with respect to a horizontal dimension and a time dimension, which may be a TWT dimension.

As an example, a seismic survey can include points referred to as downward reflection points (DRPs). A DRP is a point where seismic energy is reflected downwardly. For example, where multiple interfaces exist, seismic energy can reflect upwardly from one interface, reach a shallower interface and then reflect downwardly from the shallower interface.

As an example, a seismic survey may be an amplitude variation with offset (AVO) survey. Such a survey can record variation in seismic reflection amplitude with change in distance between position of a source and position of a receiver, which may indicate differences in lithology and fluid content in rocks above and below a reflector.

AVO analysis can allow for determination of one or more characteristics of a subterranean environment (e.g., thickness, porosity, density, velocity, lithology and fluid content of rocks, etc.). As an example, gas-filled sandstone might show increasing amplitude with offset; whereas, a coal might show decreasing amplitude with offset. AVO analysis can be suitable for young, poorly consolidated rocks, such as those in the Gulf of Mexico.

As an example, a method may be applied to seismic data to understand better how structural dip may vary spatially with respect to offset and/or angle as may be associated with emitter-detector (e.g., source-receiver) arrangements of a survey, for example, to estimate how suitable individual offset/angle gathers are for AVO imaging. As explained, a gather may be a collection of seismic traces that share an acquisition parameter, such as a common midpoint (CMP), with other collections of seismic traces. For example, consider an AVO survey that includes a plurality of emitter-detector arrangements (e.g., source-receiver pairs) with corresponding angles defined with respect to a common midpoint (CMP). Given a CMP, acquired survey data may be considered to cover a common subsurface region (e.g., a region that includes the midpoint).

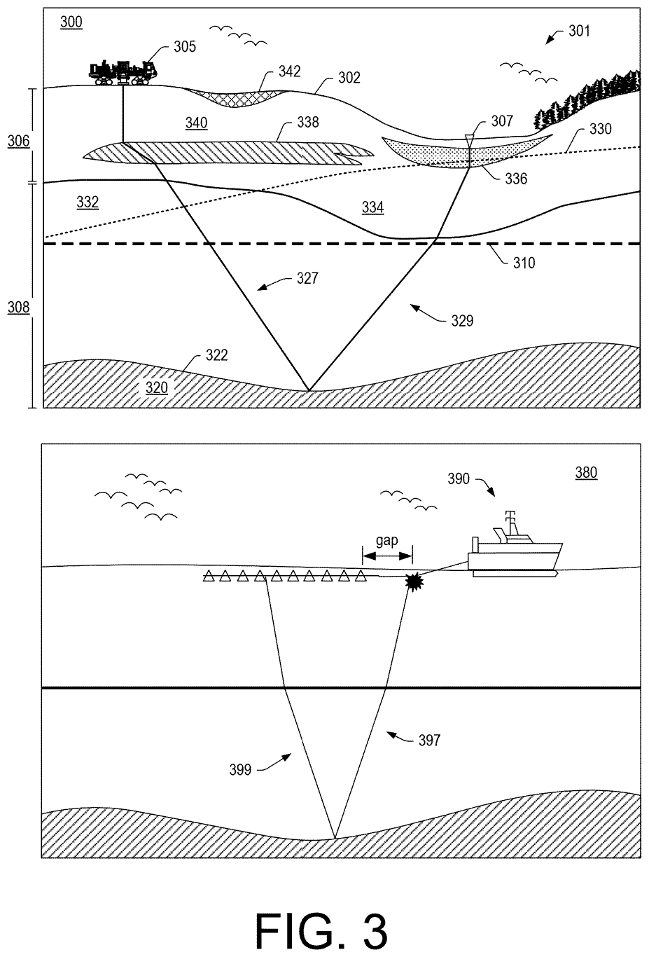

FIG. 3 shows an example of a land system 300 and an example of a marine system 380. The land system 300 is shown in a geologic environment 301 that includes a surface 302, a source 305 at the surface 302, a near-surface zone 306, a receiver 307, a bedrock zone 308 and a datum 310 where the near-surface zone 306 (e.g., near-surface region) may be defined at least in part by the datum 310, which may be a depth or layer or surface at which data above are handled differently than data below. For example, a method can include processing seismic data that aims to “place” the source 305 and the receiver 307 on a datum plane defined by the datum 310 by adjusting (e.g., “correcting”) traveltimes for propagation through the near-surface region (e.g., a shallower subsurface region).

In the example system 300 of FIG. 3, the geologic environment 301 can include various features such as, for example, a layer 320 that defines an interface 322 that can be a reflector, a water table 330, a leached zone 332, a glacial scour 334, a buried river channel 336, a region of material 338 (e.g., ice, evaporates, volcanics, etc.), a high velocity zone 340, and a region of material 342 (e.g., Eolian or peat deposits, etc.).

In FIG. 3, the land system 300 is shown with respect to downgoing rays 327 (e.g., downgoing seismic energy) and upgoing rays 329 (e.g., upgoing seismic energy). As illustrated the rays 327 and 329 pass through various types of materials and/or reflect off of various types of materials.

Various types of seismic surveys can contend with surface unevenness and/or near-surface heterogeneity. For example, a shallow subsurface can include large and abrupt vertical and horizontal variations that may be, for example, caused by differences in lithology, compaction cementation, weather, etc. Such variations can generate delays or advances in arrival times of seismic waves passing through them relative to waves that do not. By accounting for such time differences, a seismic image may be of enhanced resolution with a reduction in false structural anomalies at depth, a reduction in mis-ties between intersecting lines, a reduction in artificial events created from noise, etc.

As an example, a method can include adjusting for such time differences by applying a static, or constant, time shift to a seismic trace where, for example, applying a static aims to place a source and receiver at a constant datum plane below a near-surface zone. As an example, an amount by which a trace is adjusted can depend on one or more factors (e.g., thickness, velocity of near-surface anomalies, etc.).

In FIG. 3, the datum 310 is shown, for example, as a plane, below which strata may be of particular interest in a seismic imaging workflow. In a three-dimensional model of a geologic environment, a near surface region may be defined, for example, at least in part with respect to a datum. As an example, a velocity model may be a multidimensional model that models at least a portion of a geologic environment. As an example, an earth model may be or include a velocity model (e.g., one or more parameters as to one or more physical characteristics that may have an effect on seismic velocity).

In the example of FIG. 3, the source 305 can be a seismic energy source such as a vibrator. As an example, a vibrator may be a mechanical source that delivers vibratory seismic energy to the Earth for acquisition of seismic data. As an example, a vibrator may be mounted on a vehicle (e.g., a truck, etc.). As an example, a seismic source or seismic energy source may be one or more types of devices that can generate seismic energy (e.g., an air gun, an explosive charge, a vibrator, etc.).

Vibratory seismic data can be seismic data whose energy source is a vibrator that may use a vibrating plate to generate waves of seismic energy. As an example, the frequency and the duration of emitted energy can be controllable, for example, frequency and/or duration may be varied according to one or more factors (e.g., terrain, type of seismic data desired, etc.).

As an example, a vibrator may emit a linear sweep of a duration that is of the order of seconds (e.g., at least seven seconds, etc.), for example, beginning with high frequencies and decreasing with time (downsweeping) or going from low to high frequency (upsweeping). As an example, frequency may be changed (e.g., varied) in a nonlinear manner (e.g., certain frequencies are emitted longer than others, etc.). In various vibrator scenarios, resulting source wavelet can be one that is not impulsive. As an example, parameters of a vibrator sweep can include start frequency, stop frequency, sweep rate and sweep length.

As an example, a vibrator may be employed in land acquisition surveys for areas where explosive sources may be contraindicated (e.g., via regulations, etc.). As an example, more than one vibrator can be used simultaneously (e.g., in an effort to improve data quality, etc.).

As an example, a receiver may be a may be a UNIQ sensor unit (SLB, Houston, Texas). As an example, a sensor unit can include a geophone, which may be configured to detect motion in a single direction. As an example, a geophone may be configured to detect motion in a vertical direction. As an example, three mutually orthogonal geophones may be used in combination to collect so-called 3C seismic data. As an example, a sensor unit that can acquire 3C seismic data may allow for determination of type of wave and its direction of propagation. As an example, a sensor assembly or sensor unit may include circuitry that can output samples at intervals of 1 ms, 2 ms, 4 ms, etc. As an example, an assembly or sensor unit can include an analog to digital converter (ADC) such as, for example, a 24-bit sigma-delta ADC (e.g., as part of a geophone or operatively coupled to one or more geophones). As an example, a sensor assembly or sensor unit can include synchronization circuitry such as, for example, GPS synchronization circuitry with an accuracy of about plus or minus 12.5 microseconds. As an example, an assembly or sensor unit can include circuitry for sensing of real-time and optionally continuous tilt, temperature, humidity, leakage, etc. As an example, an assembly or sensor unit can include calibration circuitry, which may be self-calibration circuitry.

In FIG. 3, the system 380 includes equipment 390, which can be a vessel that tows one or more sources and one or more streamers (e.g., with receivers). In the system 380, a source of the equipment 390 can emit energy at a location and a receiver of the equipment 390 can receive energy at a location. The emitted energy can be at least in part along a path of the downgoing energy 397 and the received energy can be at least in part along a path of the upgoing energy 399.

In various systems, for one or more reasons, a gap in coverage may exist. For example, in the system 380 a gap is identified and labeled where the gap may be defined as a distance between a seismic source and a seismic receiver. In such an example, the distance may be considered a practical or a safe distance for locating a seismic receiver from a seismic source. If a seismic receiver is too close to a seismic source, the seismic receiver may experience a rather large shock wave and/or may otherwise experience energy that may be quite high and raise concerns with calibration, dynamic range, etc.

In the examples of FIG. 3, the paths are illustrated as single reflection paths for sake of simplicity. In the environments illustrated, additional interactions, reflections can be expected. For example, ghosts may be present. A ghost can be defined as a short-path multiple, or a spurious reflection that occurs when seismic energy initially reverberates upward from a shallow subsurface and then is reflected downward, such as at the base of weathering or between sources and receivers and the sea surface. As an example, the equipment 390 can include a streamer that is configured to position receivers a distance below an air-water interface such that ghosts can be generated where upgoing energy impacts the air-water interface and then reflects downward to the receivers. In such an example, a process may be applied that aims to “deghost” seismic data. Deghosting can be applied to marine seismic survey data where such a process aims to attenuate signals that are downgoing from an air-water interface (e.g., a sea surface interface). As mentioned, one or more other techniques, technologies, etc., may be utilized for seismic surveying (e.g., ocean bottom cables, ocean bottom nodes, etc.).

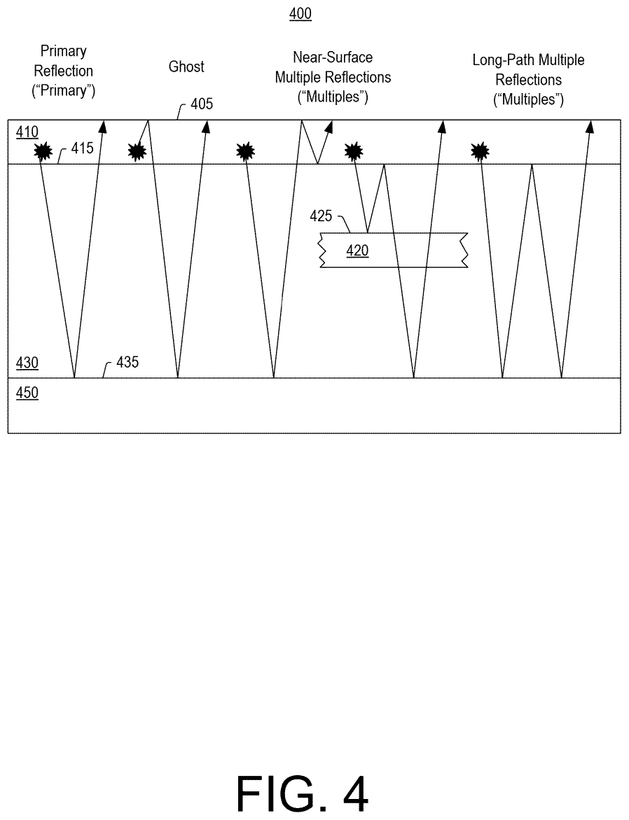

FIG. 4 shows examples of paths of seismic energy in various environments 400. As shown, an environment may include layers 410, 420, 430, and 450 and interfaces 405, 415, 425, and 435. As explained, a seismic survey may be performed using one or more sources, for example, as indicated by starbursts in the examples of FIG. 4.

As shown in FIG. 4, for a primary reflection or primary, a source can emit energy that travels into the layer 430 where a portion of that energy is reflected by the interface 435 such that a reflected portion of energy travels upwardly to surface.

As shown in FIG. 4, for a ghost, which is a type of multiple reflection or multiple, a source may be disposed below the interface 405, which may be an air-water interface, where a portion of the energy is reflected by the interface 405 and travels downwardly into the layer 430 where it is reflected by the interface 435, upon which a reflected portion travels upwardly to surface. As explained, a ghost may also be generated where a receiver is disposed below an air-water interface. For example, consider a receiver disposed below the interface 405 such that the upwardly reflected energy is again reflected, now by the interface 405, after which it travels to the receiver as disposed below the interface 405. In such an example, the energy reflected from the interface 435 may be received by that receiver in an upgoing manner while the ghost (e.g., ghost energy) may be received by that receiver in a downgoing manner, as delayed and degraded by reflection off the interface 405. As explained, ghosts, as may occur in seismic marine surveys, may present as noise in seismic signals at a receiver, which, in turn, can decrease signal-to-noise ratio and make seismic imaging more challenging.

As shown in FIG. 4, for a near-surface multiple reflection or multiple, the interfaces 405 and 415 may be involved as reflecting interfaces or, for example, another interface such as the interface 425 may be involved along with the interface 415. Such types of multiples may be referred to as near-surface or short-path as features of interest may be quite deep relative to such near-surface features.

As shown in FIG. 4, for a long-path multiple reflection or multiple, reflections may occur with respect to the interfaces 415 and 435 where the interface 435 is deeper than the interface 415. As shown via ray-tracing, the long-path multiple has a ray trace length that is greater than that of the example near-surface or short-path multiples.

As explained, in seismic signals, an event may be associated with a structural feature. For example, an event may be an appearance of seismic data as a diffraction, reflection, refraction or other feature produced by an arrival of seismic energy. As an example, an event may be a single wiggle within a trace, or a consistent lining up of several wiggles over several traces. As an example, an event in a seismic section may represent a geologic interface, such as a fault, unconformity or change in lithology.

As an example, a multiple may be an event in which one deeper and one near-surface reflector, such as the base of weathering or the ocean floor, are involved; noting that various other environments may generate multiples during seismic surveys. As explained with respect to the example long-path multiple, seismic energy may bounce twice from a deep reflector (see, e.g., the interface 435) and only once from a shallow reflector (see, e.g., the interface 415), causing a multiple to appear at roughly twice the traveltime of a corresponding primary reflection or primary.

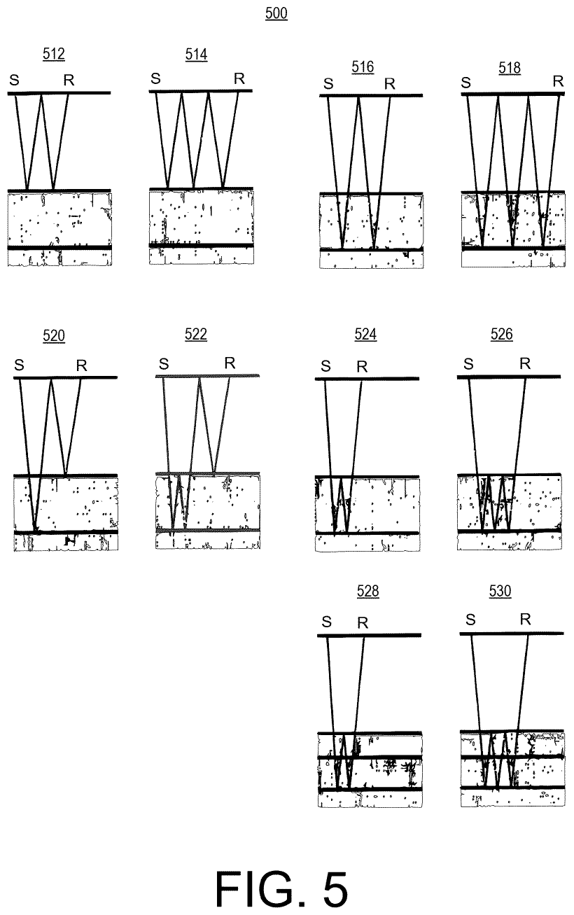

FIG. 5 shows some examples of multiples 500, which include examples 512, 514, 516, 518, 520, 522, 524, 526, 528, and 530. These examples are shown using ray-paths associated with the various examples of types of multiples. In the examples of FIG. 5, the shallowest interface in each case may represent a water bottom (e.g., a seabed, etc.). Specifically, the examples of multiples 500 may be for water-bottom multiples of first- and second-order 512 and 514, free-surface multiples of first- and second-order 516 and 518, peg-leg multiples of first- and second-order 520 and 522, intrabed multiples of first- and second-order 524 and 526, and interbed multiples of first- and second-order 528 and 530.

Again, FIG. 5 shows some examples, which are but a few of the numerous configurations of ray-paths associated with multiple reflections that may be encountered in recorded data (e.g., seismic signals). As an example, multiples may exhibit common properties that may be exploited to attenuate them, as appropriate, with varying degree of success. For example, consider periodicity and moveout as common properties of multiples that differ from those of primaries.

As an example, a seismic imaging framework may provide for attenuation of multiples such that primaries may be more prominent and allow for improved identification of structural features in a subsurface environment. As an example, multiple reflections and reverberations may be attenuated using various techniques, which may be based on their periodicity or differences in moveout velocity between multiples and primaries. Such techniques may be applied to data in one or more of various domains, which may include, for example, a CMP domain, etc., to best exploit the periodicity and velocity discrimination criteria (noise and multiple attenuation).

As an example of a technique, consider deconvolution, which aims to exploit a periodicity criterion. In various instances, despite theoretical limitations, deconvolution may remove a substantial portion of the energy associated with short-period multiples and reverberations. It may also attenuate long-period multiples if it is applied in data domains in which periodicity is preserved (noise and multiple attenuation).

As an example, adaptive subtraction may be utilized as a technique for attenuation of multiples, which may be applied to pre-stack or post-stack seismic data. As explained, multiples may be types of echoes caused by one or more of a variety of circumstances where multiples may be considered noise to be attenuated such that a seismic section exhibits mainly primary reflections. As an example, adaptive subtraction can involve generating a multiple model where the multiple model may be subtracted from recorded seismic data.

In adaptive subtraction, more than a simple subtraction is employed because the energy of a multiple model tends to have different amplitudes, frequency range, and phase compared to recorded energy of a seismic survey. Hence, to perform an effective subtraction (e.g., recorded energy−multiple model energy=primary energy), recorded data and the multiple model demand synchronization such as, for example, synchronization in amplitude, time, phase, and frequency. Adaptive subtraction aims to provide for synchronization, for example, to adapt a multiple model to match recorded seismic energy to make a subtraction effective.

As an example, an adaptive subtraction technique may involve various actions in adapting a multiple model. For example, consider implementation of a match filter that may apply a filter to one set of values to make it more similar to another set of values. In this example, the filter may be used to match a multiple model to recorded data. Hence, a match filtering component may be a component of an adaptive subtraction framework (e.g., package, library, etc.).

As an example, an adaptive subtraction framework may provide for implementation of one or more types of techniques. For example, consider extended internal multiple prediction (XIMP), which is a data-driven multiple-modeling technique that predicts internal multiples from recorded events using wavefield extrapolation. XIMP does not demand a prior velocity function to differentiate between primaries and internal multiples. XIMP uses onset times of multiple-generating events in seismic data to provide an accurate model of multiple energy, which may then be employed for multiples attenuation using adaptive subtraction.

As explained, seismic image quality tends to be dependent on primary seismic reflection energy. However, for one or more reasons, reflection signals may be contaminated with noise. Such noise may be from multiples, which may include, for example, one or more of surface-related and internal multiples, which may be dominant coherent noises observed in recorded data. As explained, attenuation of multiple energy may be employed as part of a workflow that aims to improve seismic image quality.

As explained, adaptive subtraction may be employed as part of a multiple attenuation process where adaptive subtraction may involves predicting multiple responses, designing a matching filter to transform the signature of the predicted multiple, and adaptively subtracting these from recorded signals to retain, predominantly, primary reflection events. In such an example, a matching filter may perform a convolutional operation that aims to adjust for differences between predicted multiples, and actual multiples in recorded data. In various scenarios, filter design may be a considerably time-consuming task as it can demand iteratively adjusting one or more filter parameters to account for, (1) a dimensional-shift introduced by the source and receiver depths, (see, e.g., Abma et al., 2005, “Comparisons of adaptive subtraction methods for multiple attenuation”, The Leading Edge, 24(3): 277-280. https://doi.org/10.1190/1.1895312, which is incorporated by reference herein in its entirety), and (2) the amplitude intensity difference. As an example, a framework may implement one or more machine learning techniques that may provide for expedited model design (e.g., expedited model generation), which may provide for expediting one or more workflows while improving results (e.g., image quality, etc.).

As an example, a dimensional-shift may be a temporal shift and/or a spatial shift. As explained, time and depth may be transformable such that time may be transformed to depth and depth may be transformed to time. As an example, a dimensional-shift may be in one or more dimensions of a coordinate system. For example, consider a dimensional-shift that may be vertical and/or lateral, which may depend on complexity. As an example, a dimensional-shift may be a time-shift and/or a spatial-shift. As an example, consider a shift term that may be a 1D (vertical shift) or 2D (both vertical and horizontal shifts); noting that, in various instances, a 3D shift may be employed. As an example, a domain may include a time dimension (e.g., as a proxy for depth) and a spatial dimension as a lateral dimension. In such an example, one or more dimensional-shifts may be employed.

As an example, a seismic imaging framework may employ one or more machine learning (IL) techniques that may be, for example, based on image-to-image transformation. Such an approach may provide a technical solution to a highly technical problem. For example, such an approach may provide a viable solution to design a nonlinear operator for improving the performance of adaptive subtraction.

As mentioned, various approaches may be data-driven, however, they may demand integration of a supervised network to convert an input predicted multiple into a corresponding targeted signal. While such supervised-network, data-driven approaches have shown some potentiality, they face challenges. In particular, a major challenge faced by a supervised network is the powerful generative capability of the supervised network itself. For example, if not properly constrained, a supervised ML model may perfectly transform predicted multiples into actual seismic responses, leading to complete removal of primary events after multiple suppression. Hence, a supervised ML model demands constraint; otherwise, the desirable signal inherent in primaries can be lost upon removal of noise.

As an example, a seismic imaging framework may employ one or more unsupervised ML techniques. In such an example, challenges inherent in supervised ML techniques may be mitigated. For example, consider implementation of an unsupervised ML model that may provide for an optimized nonlinear operator, which may, for example, be utilized for adaptive subtraction. As an example, an unsupervised ML model may be employed that automatically estimates both the optimal dimensional-shift between predicted models and actual data, and the spatial-varying scaling factors that adjust for amplitude difference. In contrast to a supervised ML model workflow, an unsupervised ML model may intake both the actual seismic response and a predicted model, and output dimensional-shift values, spatial-varying scaling factors, and transformed predicted multiples that have similar characteristics of actual seismic responses.

As an example, an unsupervised ML approach may be implemented without a human in the loop (HITL) or, for example, with minimal HITL demand, particularly compared to a supervised ML approach. As explained, an unsupervised ML approach may provide for directly tackling dimensional-shifts and amplitude differences, such that there is a substantial reduction in computation time, while minimizing undesirable removal or other attenuation of primary reflection events.

As an example, an unsupervised ML approach may provide for generation of a multiple model, which, in turn, may be utilized for one or more purposes. In various instances, multiples may include useful information. For example, in one or more regions that may be poorly illuminated by primaries, a workflow may resort to multiples for information to determine structure in a subsurface environment (e.g., multiples may provide for illumination of structures from angles primaries don't reach). Hence, as an example, a seismic imaging framework may include an unsupervised ML approach for generation of a multiple model where that multiple model may be utilized to attenuate multiples and/or to assess information contained within multiples. In various instances, attenuation of multiples may be referred to as a demultiple approach or multiples removal, noting that a full 100 percent removal of multiples, without degradation of primaries, is generally unachievable. As an example, a 50 percent reduction in multiples may provide for improvement, where a 75 percent to 95 percent reduction may be desirable.

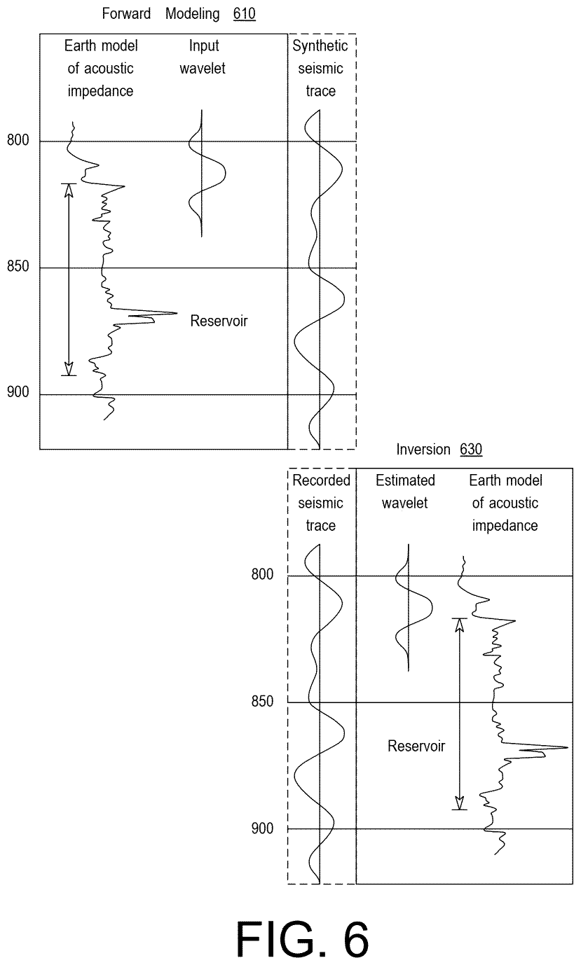

FIG. 6 shows an example of forward modeling 610 and an example of inversion 630 (e.g., an inversion or inverting). As shown, the forward modeling 610 progresses from an earth model of acoustic impedance and an input wavelet to a synthetic seismic trace while the inversion 630 progresses from a recorded seismic trace to an estimated wavelet and an earth model of acoustic impedance. As an example, forward modeling can take a model of formation properties (e.g., acoustic impedance as may be available from well logs) and combine such information with a seismic wavelength (e.g., a pulse) to output one or more synthetic seismic traces while inversion can commence with a recorded seismic trace, account for effect(s) of an estimated wavelet (e.g., a pulse) to generate values of acoustic impedance for a series of points in time (e.g., depth).

As an example, an earth model of formation properties may be utilized to generate primaries, multiples, or primaries and multiples. For example, consider a workflow where an earth model (e.g., or velocity model, etc.) may be utilized in forward modeling to generate an initial multiple model. In such an example, the synthetic seismic trace of FIG. 6 may be a multiples trace, which may be representative of an estimate of actual multiples in seismic traces as recorded during a seismic survey.

As to acoustic impedance as a formation property, acoustic impedance is the opposition of a medium to a longitudinal wave motion. Acoustic impedance is a physical property whose change determines reflection coefficients at normal incidence, that is, seismic P-wave velocity multiplied by density. Acoustic impedance characterizes the relationship between the acting sound pressure and the resulting particle velocity.

During the propagation of seismic wave along a ray-path, a seismic wave transmits through and/or reflects at a material boundary and/or converts its vibration mode between P-wave and S-wave. An observed amplitude of a seismic wave depends on an acoustic impedance contrast at a material boundary between an upper medium and a lower medium. Acoustic impedance, Z, can be defined by a multiplication of density, ρ, and seismic velocity, Vp, in each media. Acoustic impedance Z tends to be proportional to Vp for the many sedimentary and crustal rocks (e.g., granite, anorthite, pyrophyllite, and quartzite), except for some ultramafic rocks (e.g., dunite, eclogite, and peridotite) in the mantle.

As an example, an earth model may be referred to as a velocity model where, for example, one or more physical properties as may be associated with one or more subsurface structural features. For example, consider a velocity model that includes parameters as to acoustic impedance, which, as mentioned, can depend on density and seismic velocity in a material. Where an energy wave approaches a boundary (e.g., interface) between two different materials, a difference in impedance may at least in part determine how the energy wave may reflect and/or transmit.

In various instances, an inversion problem may be ill-posed for one or more reasons. Recorded data can include discrepancies including, for example, missing near offsets (e.g., due to gaps, etc.), and multiple events with other artifacts that contaminate the model of primaries that is inverted for. Artifacts can also be associated with inversion inaccuracies coming from inaccurate physics simulation (e.g., inversion of 3D data using 2D inversion, wavelet estimation errors, etc.).

For various reasons, a seismic survey may have coverage issues. For example, certain subsurface structures may impact “illumination” of one or more regions by seismic energy. In seismology, illumination can refer to an ability for seismic energy to fall on a reflector and thus be available to be reflected. Illumination can depend on source-receiver configuration (e.g., a survey geometry) and velocity distribution such as, for example, irregular velocity contrasts that may bend ray-paths differently than adjacent ray-paths. Various regions can have complicated velocity variations, for example, consider high-velocity contrast regions and subsalt regions.

A subsalt region can be an exploration and production play type in which prospects exist below salt layers. Prospecting for such regions below salt layers can pose challenges with respect to illumination, which may result in seismic data of poor quality. The Gulf of Mexico includes subsalt-producing fields; noting that subsalt regions also exist in other parts of the world such as, for example, offshore Brazil in the Santos, Campos and Espirito Santo basins.

A region below salt (e.g., a subsalt region) may be referred to as a pre-salt layer. As an example, a region may include a diachronous series of geological formations on a continental shelve of an extensional basin formed after the break-up of Gondwana, which may be characterized by deposition of thick layers of evaporites that can be composed mostly of salt. In various regions, some petroleum generated from sediments in a pre-salt layer may not have migrated upward to post-salt layers above, for example, due to one or more salt domes. Such types of regions exist off the coast of Africa and the coast of Brazil. Total pre-salt hydrocarbon reserves are estimated to be a substantial fraction of the world's hydrocarbon reserves.

Off the coast of Brazil, oil and natural gas reserves lie below an approximately 2,000 m (6,600 ft) thick layer of salt, which in turn is beneath more than 2,000 m (6,600 ft) of post-salt sediments in places, which in turn is under water depths between 2,000 m and 3,000 m (6,600 ft and 9,800 ft) in the South Atlantic. Drilling through rock and salt to extract pre-salt oil and gas can be complicated and costly. As explained, seismic surveying can be challenging in such regions, which can introduce uncertainties in planning, drilling, etc.

A 3D seismic dataset can be referred to as a cube or volume of data; a 2D seismic data set can be referred to as a panel of data. To interpret 3D data, processing can be on the “interior” of the cube, which tends to be an intensive computation process because massive amounts of data are involved. For example, a 3D dataset can range in size from a few tens of megabytes to several terabytes or more.

A 3D seismic data volume can include a vertical axis that is two-way traveltime (TWT) rather than depth and can include data values that are seismic amplitudes values. Such data may be defined at least in part with respect to a time axis where a trace may be a data vector of values with respect to time.

As explained, a seismic imaging framework may provide for forward modeling to generate a multiple model using an earth model (e.g., a velocity model). As an example, such a model may be a synthetic model that may be utilized as an initial model.

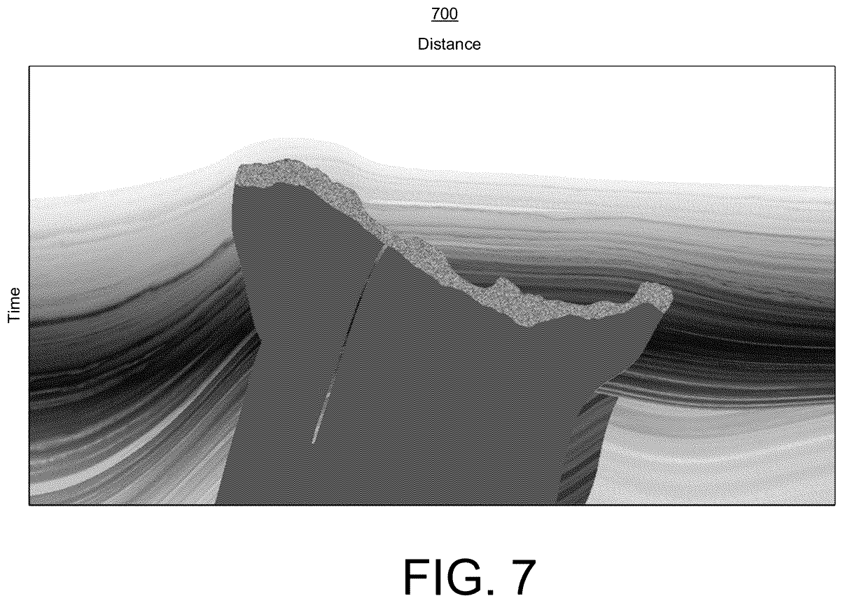

FIG. 7 shows an example of an earth model 700, which is shown with respect to surface coordinates and depth and/or time coordinates, where various colors, shades, gradations, etc., may provide for indication of one or more physical properties (e.g., one or more velocity-related properties, etc.). The earth model 700 may be utilized in a forward modeling approach, for example, where one or more sources may be modeled for emission of energy that may be reflected by various structural features in the earth model 700. As explained, such an approach may be employed to generate multiples, which may be multiples of a multiple model suitable for use in one or more workflows.

As explained, an unsupervised ML approach may be implemented for generation of a multiple model, which may be a refined multiple model. For example, consider a workflow where an initial multiple model is provided and where that initial multiple model may be iteratively refined using one or more ML models, which may include one or more ML models that involve unsupervised learning.

As an example, deep learning (DL) may be implemented to compute dimensional-shifts that aim to align modeled multiples and multiples in recorded seismic data, and to compute amplitude scalers that aim to balance amplitude differences between modeled multiples and multiples in recorded seismic data.

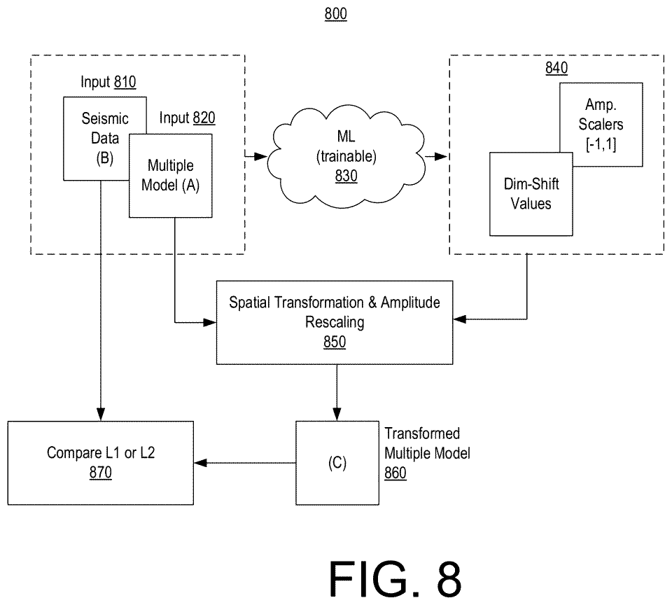

FIG. 8 shows an example of a workflow 800, which includes inputs 810 and 820 for an ML model 830, which generates output 840, which may include amplitude scalars and dimensional-shift values. For example, consider the input 810 as being seismic data and the input 820 as being a multiple model which may be defined, for example, in a 2D space. In such an example, the output 840 may be in a 2D array (e.g., matrix, etc.) that corresponds to the 2D space. In such an example, the discretization of the input 810 and the input 820 may be the same, for example, corresponding to a pixel array or other array as may be characterized by length and width dimensions. In such an example, the output 840 may be in a corresponding array. In various instances, upsampling and/or downsampling may be utilized. In various instances, interpolation may be utilized. In various instances, the input seismic data 810 may be dense and/or sparse, depending on one or more factors as may be associated with an environment and/or a seismic survey. As to the input multiple model 820, as explained, it may be generated initially using forward modeling where, for example, resolution may be controllable (e.g., based on resolution of structure, properties, etc.).

As shown in the example of FIG. 8, the input multiple model 820 may be utilized in combination with the output 840, for example, by a process block 850 for spatially transforming the input multiple model 820 (e.g., A) using the dimensional-shift values along with amplitude rescaling using the amplitude scalars. As shown, the process block 850 can output a transformed multiple model 860 (e.g., C), which may be considered a refined or more accurate multiple models when compared to the input multiple model 820. As shown, the transformed multiple model 860 may be utilized in combination with the input seismic data 810 (e.g., B) for purposes of comparison, for example, using one or more metrics (e.g., L1 norm, L2 norm, etc.). As an example, an L1 norm may be computed as the sum of absolute values; whereas, an L2 norm may be computed as the square root of the sum of the squared values. Such metrics may be computed using vectors, arrays, differences between vectors, differences between arrays, etc. For example, an L1 norm and/or an L2 norm may be applied to values, errors, etc.

As an example, input data may include two multi-dimensional (2D or 3D) arrays (A and B), which may be of the same size extracted from the same location of time domain (tx) seismic data and a multiple model volume. In such an example, the seismic data may be recorded signals from field acquisition and include both primary reflection events (e.g., events of interest), and multiple events (e.g., events to be attenuated). As an example, a multiple model may include predicted multiple events based on one or more of a data-driven technique and a model-driven technique.

As an example, an ML technique may provide for extracting hidden features from input data to output two multi-dimensional arrays, which may be of the same size as the input. For example, consider one array that includes dimensional-shift values between similar events on the input arrays (A, B), and one amplitude scaler array that includes values (e.g., scalars for scaling) between [−1, 1] that represent scaling factors that may be applied to balance out amplitude variations between the input seismic data and the input multiple model. Depending on the complexity of subsurface conditions, quality of seismic data, an ML technique may be chosen from a number of different ML techniques. For example, consider a simple multilayer Convolutional Neural Network (CNN), a more complicated U-Net structure, or one or more other suitable ML architectures.

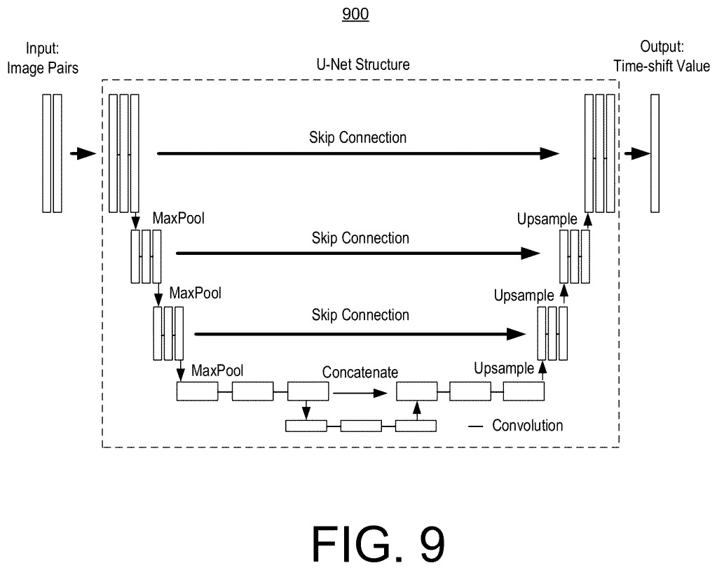

FIG. 9 shows an example of a 2D U-Net architecture that may be utilized to receive 2D input arrays. Such an architecture is described in an article by Ronneberger et al., entitled “U-Net: Convolutional Networks for Biomedical Image Segmentation”, Medical Image Computing and Computer-Assisted Intervention (MICCAI), Springer, LNCS, Vol. 9351: 234--241, 2015, available at arXiv:1505.04597, which is incorporated by reference herein in its entirety.

The U-Net architecture is a CNN architecture designed for image segmentation, which includes an encoder and a decoder, combined with skip connections. The U-Net architecture may be employed for high accuracy in pixel-wise classification tasks.

As mentioned, an ML model may include an encoder-decoder architecture, which may, for example, be arranged to form a general U-shape. For example, consider a contracting path (e.g., encoder) for context and an expansive path (e.g., decoder) for localization, which may provide for effective image segmentation. As an example, skip connections may be included as connections between encoder and decoder layers that allow for preservation of spatial information, leading to more accurate segmentation. As to data efficiency, a U-Net architecture may be effective even with relatively small datasets. For example, consider application of a U-Net approach to a portion of a seismic dataset.

As explained with respect to the example of FIG. 8, a dimensional-shift array and a multiple model array may be input into a multi-dimensional spatial transformation operator (see, e.g., the process block 850) that may perform vertical shifting of events in the multiple model using estimated values in the dimensional-shift array. In such an example, the resulting array may then be element-wise multiplied with the estimated amplitude scaler array to obtain a transformed multiple model array (C). This array (C) is expected to have similar characteristics of the input seismic data and with the multiples better aligned with those in A. An evaluation metrics between (C) and (A) may be undertaken to quantify similarities.

In the example of FIG. 8, an assumption may be present as to no substantial overlapping of multiple events and primary events. Where such an assumption is not reasonable (e.g., where substantial overlap exists of multiple events and primary events), input data may be decomposed using one or more higher dimensional operators, such as, for example, one or more of the tau-pq, f-x via Fourier, Curvelet or Discrete Wavelet Transforms (DWT). As an example, a workflow may be modified or otherwise adapted for implementation in cases where substantial overlap exists.

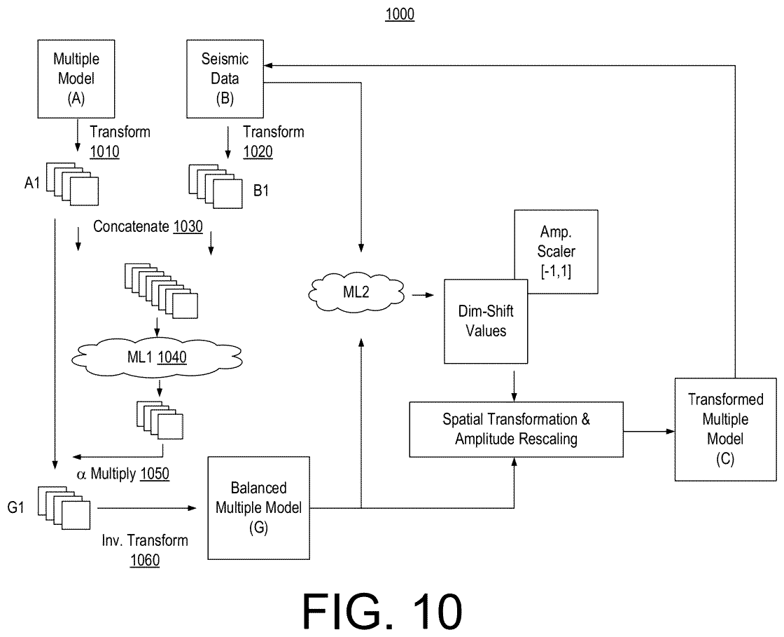

FIG. 10 shows an example of a workflow 1000 that may be a modified version of the workflow 800. As an example, a seismic imaging framework may provide for making an assessment as to overlap of multiples and primaries and selecting a particular workflow based on such an assessment. For example, consider selection of the workflow 800 or the workflow 1000 depending on extent of overlap, if any.

As shown in the example of FIG. 10, the workflow 1000 includes transformation actions 1010 and 1020 for transformation of the input multiple model (A) and the input seismic data (B), respectively. In such an example, a concatenation process 1030 may be utilized to concatenate transformation results; noting that transformation results of the transformation actions 1010 may be preserved for purposes of a multiplication process 1050. As shown, a trainable ML model 1040 may be applied to output of the concatenation process 1030 to provide output arrays that may be multiplied per the multiplication process 1050. Such actions, processes, etc., may be part of a balancing process that may then involve performing an inverse transform 1060 after the multiplication process 1050 to generate a balanced multiple model (G). As shown, the balanced multiple model (G) may be utilized in the workflow 1000 akin to the initial multiple model (B) of the workflow 800 of FIG. 8.

As an example, input data can include two multi-dimensional (2D or 3D) arrays (A and B) as may be of the same size and extracted from the same location from time domain (tx) seismic data and a multiple model volume. In such an example, the seismic data may be recorded signals from field acquisition and include both primary reflection events and multiple events. As an example, an initial multiple model may include predicted multiple events based on one or more of a data-driven approach and a model-driven approach. As an example, in various instances, one or more 1D arrays may be utilized (e.g., consider two 1D arrays).

As explained, a workflow may include balancing. For example, a seismic imaging framework may include one or more components for balancing seismic content of an input multiple model and seismic data. As shown in the example of FIG. 10, input arrays (A and B) may be transformed into a higher dimension domain via one or more transformation operators (e.g., Fourier, curvelet, DWT, etc.) to become higher-dimensional coefficient arrays A1 and B1. These higher-dimensional coefficient arrays may be concatenated into one array to input into a trainable ML model (ML 1 trainable), for example, to extract a scaling array α, which may be of the same dimensional shape as A1 and B1. Next, the array A1 may be multiplied by α to transform the higher-dimensional content of the array A toward the higher-dimensional content of the array B. Such an approach results in the array G1, which may have the same dimensional shape as A1 and B1. In the example of FIG. 10, the array G1 may be inverse transformed into an array G, which may have the same dimensional shape as A and B. In such an example, G is a balanced multiple model, which may have amplitude scaling, frequency and phase content close to that of the input seismic data (array B).

As an example, the workflow 1000 may provide for local adaptation to adjust for minor amplitude and phase mismatches between a balanced multiple model and seismic data. As shown in the example of FIG. 10, the arrays B and G may be input into a second trainable ML model (ML 2 trainable). In such an example, the ML model may extract hidden features from the input data and output two multi-dimensional arrays that may be of the same size as the input, for example, one array that includes dimensional-shifts between similar events on the input arrays (A, B), and another array that is an amplitude scaler array that includes values between (e.g., between [−1, 1]) that represent scaling factors that can balance out amplitude variations between seismic data and a multiple model.

As explained, depending on complexity of subsurface conditions and/or quality of the seismic data, an ML model may be appropriately selected. As explained, an ML model may include an encoder-decoder architecture with bridges as to information, such as, for example, in the U-Net ML model.

As an example, a dimensional-shift array and a multiple model array may be input into a multi-dimensional spatial transformation operator that performs vertical shifting of events in the multiple model using estimated values in the dimensional-shift array. Then, the resulting array may be element-wise multiplied with values in an estimated amplitude scaler array to obtain a transformed multiple model array (C). As an example, the array (C) may be expected to have similar characteristics of the input seismic data and with multiples better aligned with those in A. As an example, an evaluation of one or more metrics between (C) and (A) may be computed, for example, to quantify similarities, differences, regional issues, etc.

As explained, the workflow 1000 of FIG. 10 may provide for time domain input seismic 2D arrays that involve higher dimension data decomposition. As explained, a transform function may be selected from one or more types of transform functions (e.g., Fourier transform, curvelet or wavelet transform, etc.). As an example, an inverse transform may be an inverse of a selected transform function or selected transform functions. As an example, a forward transform and an inverse transform may be fixed operators that do not get trained during ML model training.

As an example, an adaptive subtraction process may be performed in a manner that utilizes ML where the process may be performed by iteratively utilizing various actions of the workflow 800 and/or the workflow 1000, for example, until one or more evaluation metrics are satisfied (e.g., to provide an optimal result within tolerances, etc.). As an example, an optimal result may involve the array (C) having the most similar characteristics of the input seismic data. During an optimization process, parameters in an ML model may be updated with guidance from one or more evaluation metrics, for example, via a back-propagation process. As an example, a spatial transformation operator may be a stand-alone function that may not necessarily be updated during ML model training.

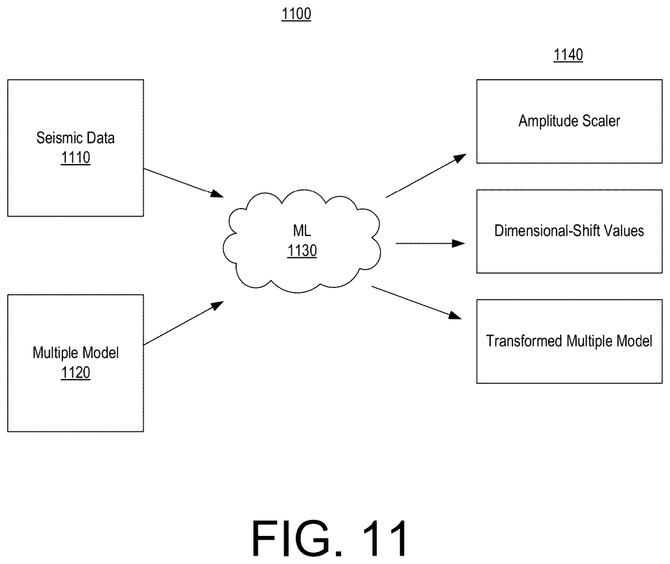

FIG. 11 shows an example of a workflow 1100 that includes input seismic data 1110 and an input multiple model 1120 that may be provided to an ML model 1130 where the ML model 1130 may generate output 1140, which may include one or more of amplitude scaler values, dimensional-shift values, and a transformed multiple model; noting that one or more other outputs may be generated, additionally or alternatively.

Because of the unsupervised nature of a selected ML model, a substantial amount of training data may not be required. As explained, the U-Net architecture may be suitable for relatively small datasets. As an example, training may be performed in an unsupervised manner where, for example, such training is performed with a few input array pairs, which may be carefully selected to represent expected features of an entire seismic dataset under investigation. As an example, a HITL may be implemented as to selection of pairs of data for training. As an example, an automated process may be implemented as to selection of training data. For example, consider an iterative approach that may involve selection of data randomly, from one or more regions, etc. In such an example, data selected may be sufficient to represent variations within the data, particularly as to variations within actual seismic data (e.g., recorded data). As an example, a seismic imaging framework may provide for computation of one or more seismic attributes that may be utilized to provide for selection of data for training. In such an example, consider a seismic attribute that may provide for characterizing signal-to-noise ratio or another metric that may provide for helping to assure that selected data reasonably represent diversity of data. As an example, a workflow may provide for choosing to output one or more different parameter arrays, which may be, for example, in addition to one or more of amplitude scaler values and dimensional-shift values. For example, as shown in FIG. 11, an output may be a transformed multiple model (e.g., as an additional output or as an alternative output).

As an example, an ML optimization process may be performed to minimize one or more evaluation metrics. For example, consider Eq. 1, below:

$$Loss = Loss 1 + c 1 Loss 2 + c 2 Loss 3 \qquad ( Eq . 1 )$$

In Eq. 1, terms include a main loss value (Loss 1) that measures similarity between a transformed multiple model (C), and input seismic data (B). As an example, to help to avoid or otherwise mitigate a substantial dimensional-shift that may lead to one or more erroneous event mismatches, and to help ensure no substantial variation throughout a dimensional-shift section, Eq. 1 may include one or more penalty terms, such as, for example, a penalty term (Loss 2), which may be an L2 norm to help ensure smooth dimensional-shift predictions, or to introduce some hard thresholding to limit the dimensional-shift values. As shown, weights c1 and c2 may be applied (e.g., consider c3, etc., for higher terms). As an example, a seismic imaging framework may provide for introducing one or more penalty terms. For example, consider introducing a penalty term to an amplitude scaler to help to avoid or otherwise mitigate unrealistic prediction values. On the other hand, to ensure that a resulting multiple model does not effectively remove some part of the primary events (e.g., signal leakage) after adaptive subtraction, a seismic imaging framework may provide for introducing one or more evaluation metrics that measure cross-correlation between an input seismic (B) and a transformed multiple model (C), or, for example, cross-correlation between demultipled seismic data (e.g., remaining energy after subtracting C from B), and a transformed model (C).

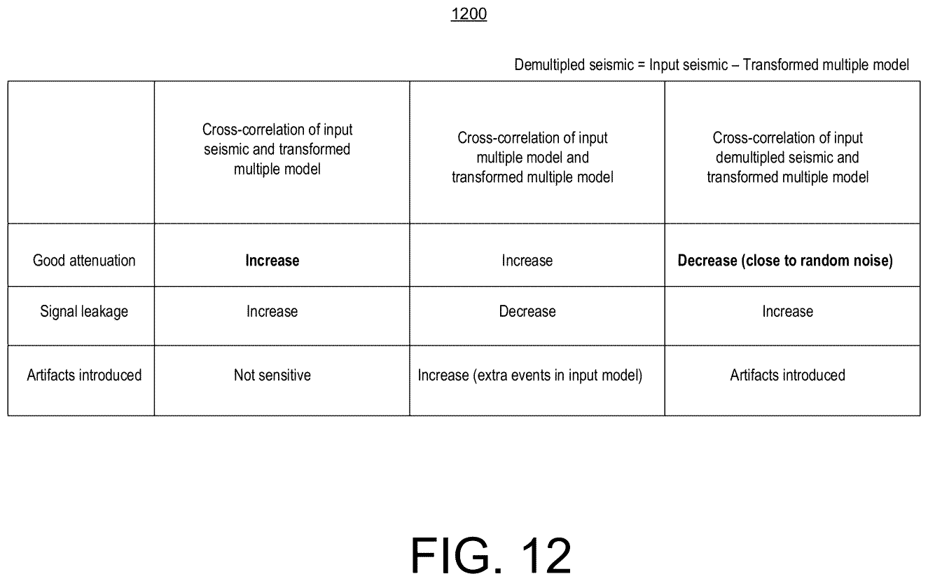

FIG. 12 shows an example table 1200. Table 1200 summarizes some expected cross-correlation value behaviors between different parameters. As an example, one or more evaluation metrics may be introduced in the Loss 3 term (e.g., or other loss terms, etc.). As an example, an approach may apply one or more weighting terms c1, c2, etc., to a loss function. In such an example, training of an ML model may not be substantially skewed by such one or more constraints (e.g., one or more additional constraints, etc.).

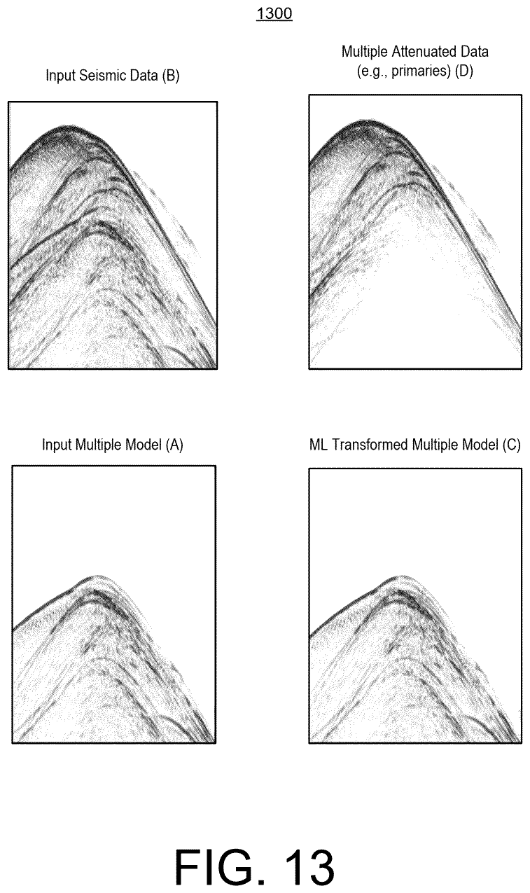

FIG. 13 shows examples of input and output 1300 from a multiples attenuation workflow as performed by a seismic imaging framework. In particular, examples of arrays (A) (e.g., multiple model) and (B) (e.g., a single shot gather) are shown as input and an example of array (C) is shown as output along with an example of the array (D) with multiples attenuated in the upper right corner (e.g., demultipled to show primaries as being predominant signal). As explained, an output of a framework may include one or more arrays, which may include a multiple model array and a multiple attenuated array as a result of attenuation of multiples in a seismic data array that includes multiples and primaries where the multiple attenuated array may exhibit primaries as signal with lesser (e.g., reduced) noise where multiples are considered to be noise. In such an example, one or more structural features as indicated by one or more primaries may be identified by human and/or machine such that a subsurface environment may be more accurately characterized.

In various examples, a multiple model, itself, may provide for more accurate characterization of a subsurface environment. As explained, in various examples, a multiple model may provide information as to subsurface structure, particularly where such subsurface structure may be not fully illuminated by primaries. As explained, multiple reflections may enter into regions of a subsurface environment that primaries may not; hence, in various instances, multiples may provide relevant information as to subsurface structure. As an example, a workflow may involve using primaries with multiples attenuated and multiples (e.g., of a multiple model) to characterize a subsurface environment.

As to a shot gather, an image may be 2D and with a third-dimension represented using color or other convention. As an example, a shot gather may have a vertical axis in time or depth where time may be in seconds or milliseconds representing two-way travel time (TWT) of a seismic wave and where depth may be utilized in processed or depth-migrated gathers (e.g., consider the vertical axis being converted to meters (m) or kilometers (km)). As to a horizontal axis, it may represent a spatial dimension, for example, consider one or more of offset, receiver/trace number, and channel index. As an example, offset may be the distance between a seismic source and each receiver, which may be measured in meters (m) or kilometers (km). As explained, a third dimension may be utilized, for example, to represent amplitude units. As an example, a “wiggle” or color intensity within a shot gather image may represent the amplitude of the recorded energy. As an example, estimated time-shift and/or estimated amplitude scaler images and/or one or more other images may be generated and rendered to a display, which may retain axes utilized for a shot gather image.

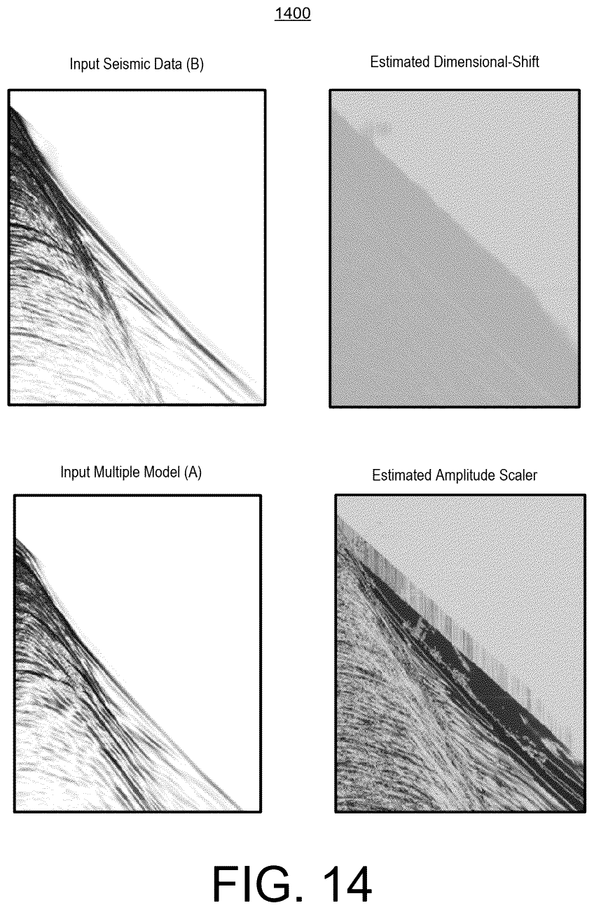

FIG. 14 shows examples of input and output 1400 from a multiple model assessment workflow as performed by a seismic imaging framework. In particular, examples of arrays (A) (e.g., a multiple model) and (B) (e.g., a single shot gather) are shown as input and examples of arrays for estimated dimensional-shift values and estimated amplitude scaler values are shown as output. As explained, such output may be utilized to generate a transformed multiple model, which may be a refined version of an input multiple model, a balanced multiple model, etc.

As explained, an unsupervised ML model-based approach may expedite one or more workflows involving multiples and primaries. Such an approach may provide for generating results using fewer computational resources and/or in lesser time. As an example, such an approach may provide for making automatic adjustments to a nonlinear operator (e.g., network parameters) during an optimization process.

As an example, a seismic imaging framework may provide for selection, adjustment, etc., of one or more hyperparameters. For example, consider one or more hyperparameters of the U-Net architecture. In such an example, the one or more hyperparameters may include hyperparameter tuning as to an optimizer, a loss function, a learning rate, a number of epochs, an architecture structure, etc. As an example, as to architecture structure, consider one or more of size of the input, configuration of convolutional layers, kernel size, and number of pooling and up-convolutional layers.

As an example, a genetic algorithm (GA) approach may be utilized for automated tuning of one or more ML model hyperparameters. For example, an automated design workflow for a CNN using GA. Such an approach may involve using a metaheuristic technique to generate a CNN architecture with a U-shape and to automatically select one or more hyperparameters, for example, in a manner that may achieve competitive performance with a much shorter architecture compared to a base U-Net architecture (see, e.g., Ronneberger et al.). As an example, a GA-U-Net workflow may commence by designing a search space and then automating design for network architecture using one or more GA operators (e.g., one or more of crossover, mutation, and selection), and searching for a competitive architecture. An article by Khouy et al., entitled “Medical Image Segmentation Using Automatic Optimized U-Net Architecture Based on Genetic Algorithm”, J Pers Med. 2023 Aug. 25; 13(9):1298 (doi: 10.3390/jpm13091298. PMID: 37763066; PMCID: PMC10533074), is incorporated by reference herein in its entirety.

As explained, a seismic imaging framework may provide for implementing an automated process that demand little to no human interaction. As explained, supervised ML approaches are formulated to perform the data transformation where the input is the multiple model, and the output is the field seismic data measurements. Such an approach can lose its generality if the training data are not carefully chosen to properly represent all potential scenarios of the subsurface conditions. In addition, due to the powerful nature of various ML algorithms, substantial human intervention can be required in calibrating the ML algorithm training process, as in some cases, the ML algorithm can perfectly transform the multiple model into the field seismic data, which leads to complete removal of the primary reflection events (e.g., signal leakage) that a user may wish to retain.

As explained, an unsupervised ML model-based approach may provide for tackling dimensional-shift and amplitude differences between a multiple model and real multiples in the seismic data. Such an approach has built-in measures that help to assure risks of signal leakage are reduced.

As an example, a seismic imaging framework may provide for performing adaptive subtraction in higher dimensional domain by decomposing input arrays using one or more domain transformations (e.g., Fourier, curvelet, wavelet, etc.).

As explained, compared to conventional non-ML methods and existing ML approaches, an unsupervised ML model-based approach may provide advantages in incorporating one or more additional evaluation constraints to an ML training process. As explained, such advantages may stem from the unsupervised nature of the ML approach, where a user and/or a machine may purposely design one or more output arrays to introduce one or more additional evaluation constraints.

As explained, a workflow may include performing unsupervised learning that automatically fine-tunes ML model parameters (e.g., weights, biases, etc.). As explained, such a workflow may allow for introduction of one or more additional evaluation constraints into a loss function, which may, for example, improve quality of an adaptive subtraction process. In such an example, an end user, therefore, may not need to spend time or may spend less time changing one or more parameters after each iteration, if required or desired.

As an example, an unsupervised ML model-based approach may be applied to one or more multiple workflows, which may utilize adaptive subtraction for multiples attenuation during signal processing.

As explained, outputs of an unsupervised ML model may include dimensional-shift values and amplitude scaler values, which may be parameters that can be used to examine one or more multiple model generation techniques. For example, such a model may provide for assessing initial model generation, refining initial model generation, etc. For example, such a model may be integrated into a loop that includes forward modeling whereby one or more aspects of forward modeling may be improved that may, in turn, provide an improved initial model.

As explained, automatic computations of an unsupervised ML model-based approach may be leveraged in performing the adaptive subtraction. Unlike existing data-driven supervised ML model-based approaches, which tend to be prone to signal leakage, an unsupervised approach may directly tackle dimensional-shift and amplitude differentiation between a multiple model and real multiples in seismic data. Accordingly, risks of signal leakage may be reduced with assurances that may not exist when using a supervised ML model-based approach. As explained, a framework may provide for adding one or more output arrays, for example, to introduce one or more additional evaluation constraints into a loss function.

As an example, a framework may provide for a fully automatic and data-driven approach to multiple model refinement. As explained, a framework may in various instances be operable without human inputs to prepare data if required and/or to optimize parameters and/or hyperparameters.

As an example, a framework may provide for a considerable reduction in turn-around time of demultiple projects, for example, from weeks to days.

As explained, an unsupervised ML model-based approach to assessing a multiple model with respect to seismic data may provide for improved adaptive subtraction and/or improved examination and/or evaluation of effectiveness of a multiple model generation technique.

As explained, in 4D seismic, data may be acquired for a region at two particular points in time (e.g., before production of a resource from a reservoir and after some amount of production of the resource from the reservoir). In such an example, the types of surveys may differ, with respect to type and/or acquisition geometry. As an example, a framework may provide for handling a 4D seismic project.

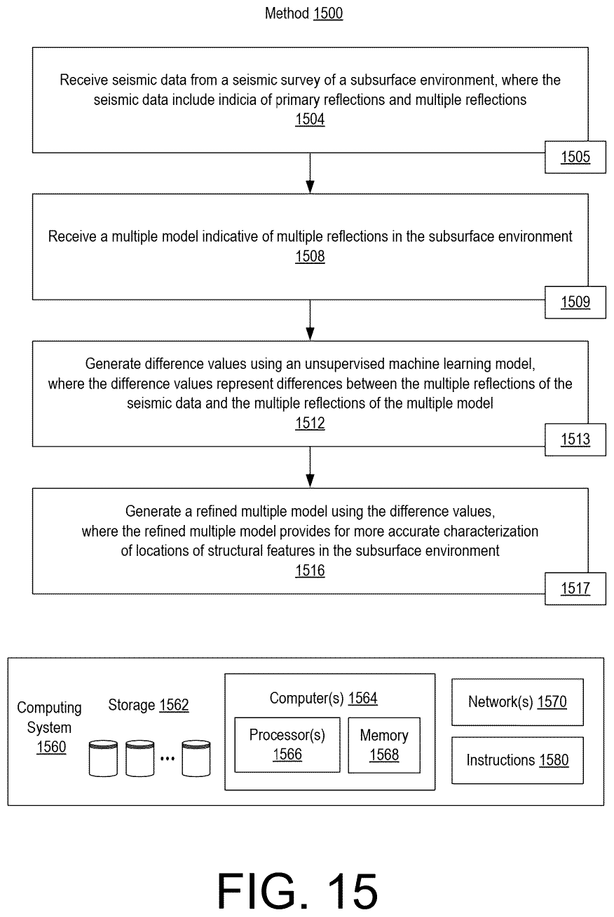

FIG. 15 shows an example of a method 1500 and an example of a computing system 1560. As shown, the method 1500 may a reception block 1504 for receiving seismic data from a seismic survey of a subsurface environment, where the seismic data include indicia of primary reflections and multiple reflections; a reception block 1508 for receiving a multiple model indicative of multiple reflections in the subsurface environment; a generation block 1512 for generating difference values using an unsupervised machine learning model, where the difference values represent differences between the multiple reflections of the seismic data and the multiple reflections of the multiple model; and a generation block 1516 for generating a refined multiple model using the difference values, where the refined multiple model provides for more accurate characterization of locations of structural features in the subsurface environment (e.g., itself, through multiple attenuation, etc.).

The method 1500 is shown in FIG. 15 in association with various computer-readable media (CRM) blocks 1505, 1509, 1513 and 1517. Such blocks generally include instructions suitable for execution by one or more processors (or cores) to instruct a computing device or system to perform one or more actions. While various blocks are shown, a single medium may be configured with instructions to allow for, at least in part, performance of various actions of the method 1500 (e.g., using the computing system 1560, etc.). A computer-readable medium (CRM) may be a computer-readable storage medium that is not a carrier wave, that is not a signal and that is non-transitory.

FIG. 15 shows the computing system 1560 as including one or more information storage devices 1562, one or more computers 1564, one or more network interfaces 1570 and instructions 1580. As to the one or more computers 1564, each computer may include one or more processors (or processing cores) 1566 and a memory 1568 (e.g., or memories) for storing instructions executable by at least one of the one or more processors. A computer may include one or more network interfaces (wired or wireless), one or more graphics cards, a display interface (wired or wireless), etc. A system may include one or more display devices (optionally as part of a computing device, etc.). Memory can be a computer-readable storage medium. A computer-readable storage medium includes, but is not limited to, a carrier wave, a signal, and a non-transitory medium.

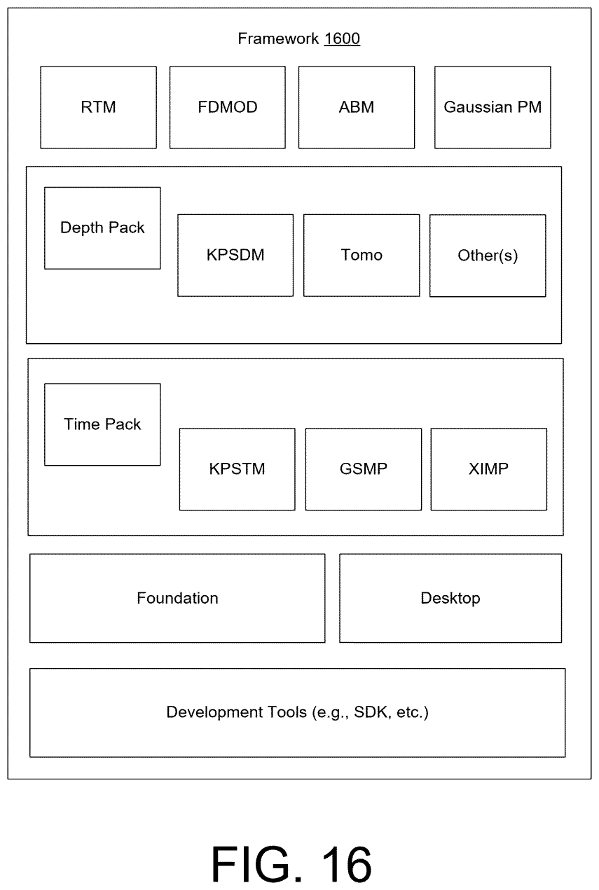

FIG. 16 shows an example of a computational framework 1600 that can include one or more processors and memory, as well as, for example, one or more interfaces. The blocks of the computational framework 1600 may be provided as instructions such as the instructions 1580 of the system 1560 of FIG. 15, etc. The computational framework of FIG. 16 can include one or more features of the OMEGA framework, which includes finite difference modelling (FDMOD) features for two-way wavefield extrapolation modelling, generating synthetic shot gathers with and without multiples. The FDMOD features can generate synthetic shot gathers by using full 3D, two-way wavefield extrapolation modelling, which can utilize wavefield extrapolation logic matches that are used by reverse-time migration (RTM). A model may be specified on a dense 3D grid as velocity and optionally as one or more of anisotropy, dip, and variable density. As explained, an earth model may include one or more parameters that may be specified spatially for a subsurface geologic region.

As shown in FIG. 16, the computational framework 1600 includes features for RTM, FDMOD, adaptive beam migration (ABM), Gaussian packet migration (Gaussian PM), depth processing (e.g., Kirchhoff prestack depth migration (KPSDM), tomography (Tomo)), time processing (e.g., Kirchhoff prestack time migration (KPSTM), general surface multiple prediction (GSMP), extended interbed multiple prediction (XIMP)), framework foundation features, desktop features (e.g., GUIs, etc.), and development tools.

The framework 1600 can include features for geophysics data processing. The framework 1600 can allow for processing various types of data such as, for example, one or more of: land, marine, and transition zone data; time and depth data; 2D, 3D, and 4D surveys; isotropic and anisotropic (TTI and VTI) velocity fields; and multicomponent data.

The framework 1600 can allow for transforming seismic, electromagnetic, microseismic, and/or vertical seismic profile (VSP) data into actionable information, for example, to perform one or more actions in the field for purposes of resource production, etc. The framework 1600 can extend workflows into reservoir characterization and earth modelling. For example, the framework 1600 can extend geophysics data processing into reservoir modelling by integrating with the PETREL framework via the Earth Model Building (EMB) tools, which enable a variety of depth imaging workflows, including model building, editing and updating, depth-tomography QC, residual moveout analysis, and volumetric common-image-point (CIP) pick QC. Such functionalities, in conjunction with depth tomography and migration algorithms of the framework 1600 can produce accurate and precise images of the subsurface. The framework 1600 may provide support for field to final imaging, to prestack seismic interpretation and quantitative interpretation, from exploration to development.

As an example, the FDMOD component can be instantiated via one or more CPUs and/or one or more GPUs for one or more purposes. For example, consider utilizing the FDMOD for generating synthetic shot gathers by using full 3D, two-way wavefield extrapolation modelling, the same wavefield extrapolation logic matches that are used by RTM. FDMOD can model various aspects and effects of wave propagation. The output from FDMOD can be or include synthetic shot gathers including direct arrivals, primaries, surface multiples, and interbed multiples. The model can be specified on a dense 3D grid as velocity and optionally as anisotropy, dip, and variable density. As an example, survey designs can be modelled to ensure quality of a seismic survey, which may account for structural complexity of the model. Such an approach can enable evaluation of how well a target zone will be illuminated. Such an approach may be part of a quality control process (e.g., task) as part of a seismic workflow. As an example, a FDMOD approach may be specified as to size, which may be model size (e.g., a grid cell model size). Such a parameter can be utilized in determining resources to be allocated to perform a FDMOD related processing task. For example, a relationship between model size and CPUs, GPUs, etc., may be established for purposes of generating results in a desired amount of time, which may be part of a plan (e.g., a schedule) for a seismic interpretation workflow.

As an example, a system, a method, etc., can utilize one or more types of ML models (e.g., predictive, classifier, etc.). As to examples of some types of ML models, consider one or more of a support vector machine (SVM) model, a k-nearest neighbors (KNN) model, an ensemble classifier model, a neural network (NN) model, etc. As an example, an ML model can be a deep learning model (e.g., deep Boltzmann machine, deep belief network, convolutional neural network, stacked autoencoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, encoder, autoencoder, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, an ML model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, the TENSORFLOW framework (Google LLC, Mountain View, CA) may be implemented, which is an open-source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train an ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system-based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a device and/or distributed devices may utilize LiteRT (formerly TENSORFLOW LITE) (Google LLC, Mountain View, California) or another type of lightweight framework. LiteRT is a set of tools that enables on-device machine learning where models may run on mobile, embedded, and IoT devices. LiteRT is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). LiteRT can provide multiple platform support, covering ANDROID and iOS devices, embedded LINUX, and microcontrollers. LiteRT can provide diverse language support, which includes JAVA, SWIFT, Objective-C, C++, and PYTHON. LiteRT can provide high performance, with hardware acceleration and model optimization. LiteRT also supports generative AI models, which may be unsupervised models. As an example, consider integration of LiteRT or another suitable framework into one or more of the PETREL, OMEGA, DEFLI, or LUMI products.

As an example, an unsupervised ML model may be trained using one framework to generated a trained ML model that may be deployed for execution using another framework, such as, for example, the LiteRT framework. In such an example, the LiteRT (runtime) may provide for execution of a trained ML model within a relatively lightweight environment, for example, by integration into an existing framework and/or operative coupling via one or more technologies (e.g., application programming interface (API), etc.). As an example, consider a workflow involving model training using a framework such as, for example, PYTORCH or TENSORFLOW, employing one or more unsupervised learning techniques; converting the trained model into an optimized LiteRT (.tflite) format using AI Edge conversion tools; and deploying the converted model on to a target edge device for execution using LiteRT (runtime). As to a target edge device, consider, for example, a laptop, a workstation, etc., which may be on land, in vehicle, on ship, in air, etc.

As explained, comparing to conventional technology, a framework, as described herein, may perform much faster in terms of computational time for the same computational resources. Further, a framework may include one or more components for automatic adjustments of a nonlinear operator (e.g., neural network parameters) during a computational optimization process. Hence, a framework may operate dynamically to improve itself, for purposes of improving computational efficiency and/or results (e.g., improved imagery, improved subsurface models, etc.).

As explained, a framework may employ unsupervised learning through use of one or more ML models that can be leveraged in an unsupervised manner. As explained, such an approach can reduce or eliminate a need for human interaction (e.g., an HITL). Hence, a framework may provide for performing workflows via automatic processes that demand little to no human interaction.

As explained, one or more supervised ML approaches may be formulated to perform data transformation where input is a multiple model, and output is field seismic data measurements. However, this setting may lose its generality if the training data are not carefully chosen to properly represent all potential scenarios of the subsurface condition. Further, in this setting, due to the powerful nature of the supervised ML approach, it demands significant human intervention in ML model calibration for the supervised training process and, in some cases, a supervised ML model may perfectly transform a multiple model into the field seismic data, which can defeat the ultimate purpose as such perfection can lead to complete removal of the primary reflection events (e.g., signal leakage) that are to be retained, as those events are generally relied upon to determine positions of subsurface structure(s).

As explained, a framework may include components that can specifically tackle time-shift and amplitude differences between a multiple model and real multiples in seismic data. Thus, such a framework can substantially reduce the perfection risk (e.g., chance of signal leakage) of a supervised ML model-based approach.

As explained, a computational framework may include components that may be optionally employed, for example, dynamically responsive to one or more conditions and/or set by one or more parameters (e.g., via a GUI interface, an instruction file, etc.). For example, consider components that provide an option to perform adaptive subtraction in a higher dimensional domain by decomposing input arrays using one or more domain transformations (e.g., Fourier transform, curvelet transform, Discrete Wavelet Transform (DWT), etc.).

In comparison to conventional non-ML methods and existing ML approaches, a computational framework as described herein delivers substantial advantages, for example, by incorporating additional evaluation constraints to an ML training process. As explained, this is a result of using an unsupervised approach (e.g., consider design of output arrays to introduce additional evaluation constraints).

As explained, a computational framework includes technological components that represent substantial improvements in the field of seismic imaging. As explained, a computational framework can provide for demand of human involvement to be reduced along with the risks inherent in approaches that rely on supervised ML models. As explained, computational efficiency, reduction in human involvement, and improved imagery may all be achieved via implementation of such a computational framework.

As explained, real-world workflows involving physics-based experiments can be expedited and/or run using fewer computational resources, along with fewer human resources, while reducing risks inherent in supervised ML model-based approach and improving image output from the physics-based experiments that reveal and characterize subsurface regions for one or more purposes, which can include identification of reservoirs, which may include one or more hydrocarbon reservoirs amenable to well drilling to produce such hydrocarbons. In other examples, a reservoir may be identified for suitability for carbon sequestration (e.g., sequestration of one or more greenhouse gases (GHGs)) where, for example, a well may be drilled for flow of carbon to such a reservoir for storage.

As an example, a method can include receiving seismic data from a seismic survey of a subsurface environment, where the seismic data include indicia of primary reflections and multiple reflections; receiving a multiple model indicative of multiple reflections in the subsurface environment; generating difference values using an unsupervised machine learning model, where the difference values represent differences between the multiple reflections of the seismic data and the multiple reflections of the multiple model; and generating a refined multiple model using the difference values, where the refined multiple model provides for more accurate characterization of locations of structural features in the subsurface environment. For example, the refined multiple model itself may provide for more accurate characterization, utilization of the refined multiple model for multiples attenuation may provide for more accurate characterization, etc.

As an example, difference values may include at least dimensional-shift values (e.g., temporal, spatial, etc.). As explained, a domain may include one or more types of dimensions, which may be spatial and/or temporal. As an example, a frequency domain may be a type of temporal domain (e.g., inverse time, etc.). As an example, a shift may be a frequency shift. As an example, where one or more seismic attributes may be utilized, a shift may be a seismic attribute shift (e.g., of appropriate dimension or dimensions, etc.).

As an example, difference values may include at least amplitude scaling values. As an example, difference values may include at least dimensional-shift values and amplitude scaling values.

As an example, an unsupervised machine learning model may be or include a convolution neural network (CNN). As an example, such a model may be a U-Net architecture model. As an example, a self-tuning model approach may be implemented.

As an example, an unsupervised machine learning model may include an encoder and a decoder. In such an example, the unsupervised machine learning model may include skip connections between the encoder and the decoder.

As an example, an unsupervised machine learning model may include a U-shape architecture (e.g., consider an encoder and a decoder, which may include skip connections).

As an example, a method may include selecting training data from one or more regions of seismic data and from one or more corresponding regions of a multiple model and performing unsupervised learning of an unsupervised machine learning model using the selected training data. In such an example, selecting may include one or more of automatically selecting (e.g., machine-based) and graphical user interface-based selecting by a human using a human-to-machine interface.

As an example, a method may include performing adaptive subtraction using seismic data and a refined multiple model to generate a multiple attenuated version of the seismic data. In such an example, the method may include performing an inversion using the multiple attenuated version of the seismic data to generate an earth model of the subsurface environment. In such an example, the method may include, using the earth model, identifying one or more reservoir regions in the subsurface environment. Such identification may be performed using a human and/or a machine. As an example, consider implementing a machine model for identifying one or more reservoir regions. As an example, an ML model such as a U-Net architecture model may be utilized to segment an earth model and/or to identify one or more types of structural features in a subsurface environment.

As an example, a multiple model may be a balanced multiple model. As an example, a method may include generating a balanced multiple model by applying one or more transforms and one or more corresponding inverse transforms prior to generating difference values.

As an example, a method may include generating difference values at least in part via implementation of a loss function. In such an example, a loss function may include one or more terms, for example, consider one or more terms that may provide for control of one or more of attenuation, signal leakage, and artifacts. As an example, difference values may include dimensional-shift values where, for example, a loss function includes a penalty term that constrains the dimensional-shift values and/or where the difference values include amplitude scaling values and where, for example, a loss function includes a penalty term that constrains the amplitude scaling values.

As an example, a system can include a processor; a memory operatively coupled to the processor; and processor-executable instructions stored in the memory to instruct the system to: receive seismic data from a seismic survey of a subsurface environment, where the seismic data include indicia of primary reflections and multiple reflections; receive a multiple model indicative of multiple reflections in the subsurface environment; generate difference values using an unsupervised machine learning model, where the difference values represent differences between the multiple reflections of the seismic data and the multiple reflections of the multiple model; and generate a refined multiple model using the difference values, where the refined multiple model provides for more accurate characterization of locations of structural features in the subsurface environment.

As an example, one or more computer-readable storage media can include computer-executable instructions executable to instruct a computing system to: receive seismic data from a seismic survey of a subsurface environment, where the seismic data include indicia of primary reflections and multiple reflections; receive a multiple model indicative of multiple reflections in the subsurface environment; generate difference values using an unsupervised machine learning model, where the difference values represent differences between the multiple reflections of the seismic data and the multiple reflections of the multiple model; and generate a refined multiple model using the difference values, where the refined multiple model provides for more accurate characterization of locations of structural features in the subsurface environment.

As an example, a computer program product can include computer-executable instructions to instruct a computing system to perform a method, for example, consider a method such as, for example, the workflow 800 of FIG. 8, the workflow 1000 of FIG. 10, etc.

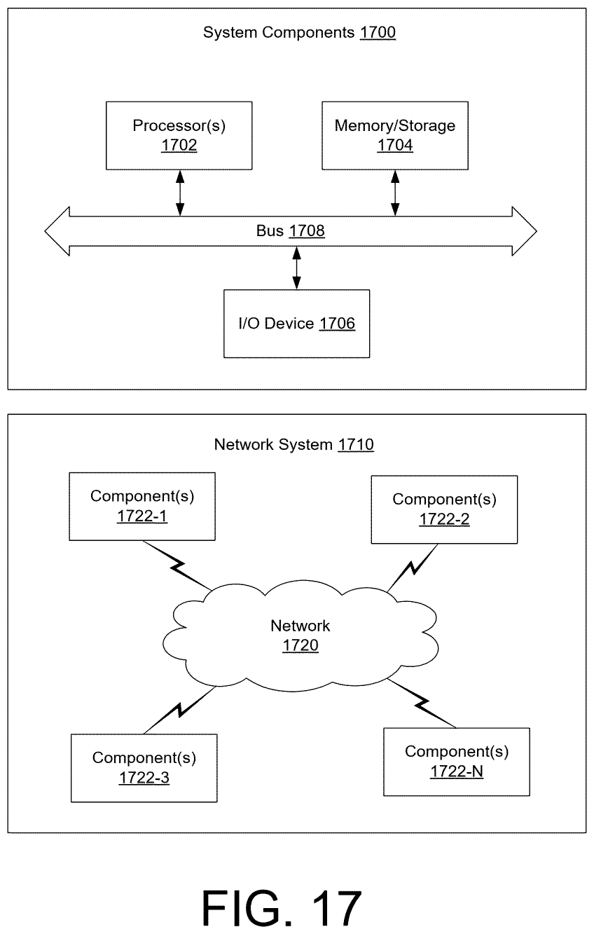

FIG. 17 shows components of a computing system 1700 and a networked system 1710 that includes a network 1720. The system 1700 includes one or more processors 1702, memory and/or storage components 1704, one or more input and/or output devices 1706 and a bus 1708. Instructions may be stored in one or more computer-readable media (memory/storage components 1704). Such instructions may be read by one or more processors (see the processor(s) 1702) via a communication bus (see the bus 1708), which may be wired or wireless. The one or more processors may execute such instructions to implement (wholly or in part) one or more attributes (as part of a method). A user may view output from and interact with a process via an I/O device (see the device 1706). A computer-readable medium may be a storage component such as a physical memory storage device such as a chip, a chip on a package, a memory card, etc. (a computer-readable storage medium).

Components may be distributed, such as in the network system 1710. The network system 1710 includes components 1722-1, 1722-2, 1722-3, . . . 1722-N. The components 1722-1 may include the processor(s) 1702 while the component(s) 1722-3 may include memory accessible by the processor(s) 1702. Further, the component(s) 1722-2 may include an I/O device for display and optionally interaction with a method. The network may be or include the Internet, an intranet, a cellular network, a satellite network, etc.

A device may be a mobile device that includes one or more network interfaces for communication of information. A mobile device may include a wireless network interface (operable via IEEE 802.11, ETSI GSM, BLUETOOTH®, satellite, etc.). A mobile device may include components such as a main processor, memory, a display, display graphics circuitry (optionally including touch and gesture circuitry), a SIM slot, audio/video circuitry, motion processing circuitry (accelerometer, gyroscope), wireless LAN circuitry, smart card circuitry, transmitter circuitry, GPS circuitry, and a battery. A mobile device may be configured as a cell phone, a tablet, etc. A method may be implemented (wholly or in part) using a mobile device. A system may include one or more mobile devices.

A system may be a distributed environment such as a so-called “cloud” environment where various devices, components, etc. interact for purposes of data storage, communications, computing, etc. A device or a system may include one or more components for communication of information via one or more of the Internet (where communication occurs via one or more Internet protocols), a cellular network, a satellite network, etc. A method may be implemented in a distributed environment (wholly or in part as a cloud-based service).

Information may be input from a display (consider a touchscreen), output to a display or both. Information may be output to a projector, a laser device, a printer, etc. such that the information may be viewed. Information may be output stereographically or holographically. As to a printer, consider a 2D or a 3D printer. A 3D printer may include one or more substances that can be output to construct a 3D object. Data may be provided to a 3D printer to construct a 3D representation of a subterranean formation. Layers may be constructed in 3D (horizons, etc.), geobodies constructed in 3D, etc. Holes, fractures, etc., may be constructed in 3D (as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
receiving seismic data from a seismic survey of a subsurface environment, wherein the seismic data comprise indicia of primary reflections and multiple reflections;
receiving a multiple model indicative of multiple reflections in the subsurface environment;
generating difference values using an unsupervised machine learning model, wherein the difference values represent differences between the multiple reflections of the seismic data and the multiple reflections of the multiple model; and
generating a refined multiple model using the difference values, wherein the refined multiple model provides for more accurate characterization of locations of structural features in the subsurface environment.

2. The method of claim 1, wherein the difference values comprise at least dimensional-shift values.

3. The method of claim 1, wherein the difference values comprise at least amplitude scaling values.

4. The method of claim 1, wherein the difference values comprise at least dimensional-shift values and amplitude scaling values.

5. The method of claim 1, wherein the unsupervised machine learning model comprises a convolution neural network (CNN).

6. The method of claim 1, wherein the unsupervised machine learning model comprises an encoder and a decoder.

7. The method of claim 6, wherein the unsupervised machine learning model comprises skip connections between the encoder and the decoder.

8. The method of claim 1, wherein the unsupervised machine learning model comprises a U-shape architecture.

9. The method of claim 1, comprising selecting training data from one or more regions of the seismic data and from one or more corresponding regions of the multiple model and performing unsupervised learning of the unsupervised machine learning model.

10. The method of claim 9, wherein the selecting comprises one or more of automatically selecting and graphical user interface-based selecting by a human using a human-to-machine interface.

11. The method of claim 1, comprising performing adaptive subtraction using the seismic data and the refined multiple model to generate a multiple attenuated version of the seismic data.

12. The method of claim 11, comprising performing an inversion using the multiple attenuated version of the seismic data to generate an earth model of the subsurface environment.

13. The method of claim 12, comprising, using the earth model, identifying one or more reservoir regions in the subsurface environment.

14. The method of claim 1, wherein the multiple model comprises a balanced multiple model.

15. The method of claim 14, comprising generating the balanced multiple model by applying one or more transforms and one or more corresponding inverse transforms prior to generating the difference values.

16. The method of claim 1, wherein the generating difference values comprises implementation of a loss function.

17. The method of claim 16, wherein the loss function comprises one or more terms to control one or more of attenuation, signal leakage, and artifacts.

18. The method of claim 16, wherein the difference values comprise dimensional-shift values and wherein the loss function comprises a penalty term that constrains the dimensional-shift values and/or wherein the difference values comprise amplitude scaling values and wherein the loss function comprises a penalty term that constrains the amplitude scaling values.

19. A system comprising:
a processor;
a memory operatively coupled to the processor; and
processor-executable instructions stored in the memory to instruct the system to:
receive seismic data from a seismic survey of a subsurface environment, wherein the seismic data comprise indicia of primary reflections and multiple reflections;
receive a multiple model indicative of multiple reflections in the subsurface environment;
generate difference values using an unsupervised machine learning model, wherein the difference values represent differences between the multiple reflections of the seismic data and the multiple reflections of the multiple model; and
generate a refined multiple model using the difference values, wherein the refined multiple model provides for more accurate characterization of locations of structural features in the subsurface environment.

20. One or more computer-readable storage media comprising computer-executable instructions executable to instruct a computing system to:
receive seismic data from a seismic survey of a subsurface environment, wherein the seismic data comprise indicia of primary reflections and multiple reflections;
receive a multiple model indicative of multiple reflections in the subsurface environment;
generate difference values using an unsupervised machine learning model, wherein the difference values represent differences between the multiple reflections of the seismic data and the multiple reflections of the multiple model; and
generate a refined multiple model using the difference values, wherein the refined multiple model provides for more accurate characterization of locations of structural features in the subsurface environment.
